(19) United States
(12) Patent Application Publication
(10) Pub. No.: US 2026/0093739 A1
(43) Pub. Date: Apr. 2, 2026

(54) SYSTEM AND METHOD OF FIRMWARE-LEVEL ARTIFICIAL INTELLIGENCE PRODUCTIVITY TOOL FOR ADJUSTING PERFORMANCE OF HARDWARE IN RESPONSE TO A RECEIVED USER QUERY INPUT

(71) Applicant: Dell Products LP, Round Rock, TX (US)

(72) Inventors: Daniel L. Hamlin, Round Rock, TX (US); Srikanth Kondapi, Austin, TX (US); Balasingh Ponraj Samuel, Round Rock, TX (US)

(73) Assignee: Dell Products LP, Round Rock, TX (US)

(21) Appl. No.: 18/904,858

(22) Filed: Oct. 2, 2024

(51) Int. Cl. G06F 16/33

(52) U.S. Cl. CPC G06F 16/3344; G06F 16/3334

(57) ABSTRACT

An information handling system executing computer readable code instructions for a firmware-level artificial intelligence productivity tool may comprise a microphone for receiving a user query input requesting an action to be taken by a hardware component of the information handling system, an embedded controller executing computer-readable code instructions for gathering natural language descriptions of firmware or hardware capabilities associated with hardware components, identifying a best match firmware or hardware capability for the received user query input having a highest lexical similarity search score comparing natural language of the user query input and a keyword in the user query input and natural language descriptions for the gathered capabilities, and instructing firmware for one of the hardware components associated with the best match firmware or hardware capability to execute the best match firmware or hardware capability in response to the user query input at a platform level, without invoking the operating system.

### FIELD OF THE DISCLOSURE

The present disclosure generally relates to an on the box (OTB) artificial intelligence (AI) productivity tool executing at the operating system level that employs machine learning models stored at an information handling system for optimizing user productivity and information handling system performance in response to a received user query input. The present disclosure more specifically relates to an agent of the OTB AI productivity tool executing at the firmware level to identify, independently from execution of the operating system, a firmware or hardware capability that may be adjusted in response to the received user query input, and to instruct firmware for the hardware associated with the firmware or hardware capability to perform the responsive capability action with that firmware or hardware capability.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more artificial intelligence (AI) productivity tool enableable software applications, chat bots, or the like. Further, the information handling system may include an on the box (OTB) artificial intelligence (AI) productivity tool employing machine learning models stored locally at the information handling system, as installed by a manufacturer of the information handling system, for optimizing user productivity and information handling system performance.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system executing machine readable code instructions for firmware-level artificial intelligence (AI) productivity tool for optimizing user experience and performance of hardware components at the information handling system according to an embodiment of the present disclosure;

FIG. 2 is a block diagram illustrating a hardware processor executing machine readable code instructions for a firmware-level AI productivity tool for correlating natural language of a user’s query input to a registered natural language description of a firmware or hardware capability for hardware component according to an embodiment of the present disclosure;

FIG. 3 is a block diagram illustrating a hardware processor executing machine readable code instructions for an on the box (OTB) AI productivity tool to instruct an AI productivity tool enableable software application perform an application capability for responding to a received user query input and operating in parallel to the firmware-level AI productivity tool according to an embodiment of the present disclosure; and

FIG. 4 is a flowchart showing a method of identifying a firmware or hardware capability of a hardware component at the firmware level with a firmware-level AI productivity tool and an application capability of an AI productivity tool enableable software application at the operating system level in parallel that best matches a received user query input for a response according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Artificial intelligence (AI) is a developing technology that is used to increase efficiency of computing systems and interactions with humans. An example of AI technologies includes, but is not limited to, chat-enabled environments (voice, text, etc.). These chat-enabled environments are described in embodiments herein as an on the box (OTB) AI productivity tool that receives this voice or text input from a user and implements a number of actions or utilizes services of various software applications based on the natural language of the input. In some information handling systems, the OTB AI productivity tool may interface with various AI productivity tool-enablable software applications being executed or executable on the information handling system. These AI productivity tool-enablable software applications may integrate with the OTB AI productivity tool to allow user queries to trigger certain actions declared, supported, and managed by these AI productivity tool-enablable software applications. Further, the OTB AI productivity tool executing at the operating system level may work in tandem with an agent, referred to herein as a firmware-level AI productivity tool, to allow the same user queries to trigger certain actions declared and supported by firmware for various hardware components of the information handling system.

An embedded controller executing code instructions of the firmware-level AI productivity tool in embodiments herein may match these received user queries, or user query inputs to known firmware or hardware capabilities of one or more hardware components through execution by the embedded controller of machine readable code instructions for one or more natural language processing machine learning models. A hardware processor executing code instructions of the OTB AI productivity tool in embodiments herein may match the same received user queries, or user query inputs to known application capabilities of one or more of the AI productivity tool-enableable software applications through execution by the hardware processor of machine readable code instructions for one or more natural language processing machine learning models executing at the operating system and having similar but more robust operations than the natural language processing machine learning models executing at the firmware level via the firmware-level AI productivity tool.

These processes include gathering, either in real-time or prior to execution of either the OTB AI productivity tool or the firmware-level AI productivity tool, firmware or hardware capabilities for a plurality of hardware components and application capabilities associated with each of a plurality of AI productivity tool-enablable software applications. These firmware or hardware capabilities and application capabilities may describe those functionalities of each of the hardware components and each of the AI productivity tool-enablable software applications, respectively, that may be used when interfacing with the OTB AI productivity tool. The natural language descriptions of the firmware or hardware capabilities for the hardware components may be stored within a natural language hardware capability library within memory of the embedded controller for a lexical or keyword comparison, via the embedded controller to received user query inputs, for example, in order to identify a firmware or hardware capability most likely to address a user’s request within the received user query inputs.

The natural language descriptions of the application capabilities for the AI productivity tool-enableable software applications may be stored within a natural language capability database in a main memory for the information handling system for semantic comparison, via the hardware processor to received user query inputs, for example, in order to identify an application capability most likely to address a user’s request within the received user query inputs. Thus, the stored natural language descriptions of firmware or hardware capabilities may be condensed in comparison to the much larger database of natural language descriptions of application capabilities stored in the main memory and executable at the operating system level. In addition, the OTB AI productivity tool executing at the operating system level may perform a semantic comparison of the user query input and each of the stored natural language descriptions of the application capabilities to identify an application capability executable within an AI productivity tool-enableable software application to perform a requested action by the operating system within the user query input. In contrast, the firmware-level AI productivity tool executing at the firmware level may perform a less complex and less processor-intensive lexical or keyword comparison of the same user query input and each of the stored natural language descriptions of the firmware or hardware capabilities to identify a firmware or hardware capability executable within firmware for a specific hardware component to perform a requested action within the user query input. Thus, the OTB AI productivity tool at the operating system (OS) level executing in tandem with the firmware-level AI productivity tool in embodiments herein may respond to a single user query input requesting that an action be taken, such as “optimize my system,” by performing an action within an AI productivity tool-enableable software application and by direct matching to perform a responsive capability action within firmware for a hardware components, such as adjusting settings or functionality thereof.

Upon receipt of a user query input at the OTB AI productivity tool executing at the operating system, or detection of receipt of such a user query input at firmware for the microphone or camera in embodiments herein, audio or image data of the user query input may be translated to text via an automatic speech recognition module or image recognition module operating within the firmware of the microphone or camera, respectively. An embedded controller executing code instructions of a lexical similarity search module at the firmware level in embodiments may then perform a lexical similarity search method to match the natural language of the received user query input with a natural language description of a firmware or hardware capability stored in the natural language hardware capabilities library in order for the embedded controller to identify a firmware or hardware capability for hardware component of the information handling system that most closely corresponds and can address the user request within the user query input. A lexical similarity search methodology for matching text or documents in embodiments herein may center upon keyword searches, such as term frequency-inverse document frequency (TF-IDF) searches. TF-IDF searches in this context focus upon the frequency of a term or keyword found within a user query input and within known firmware or hardware capabilities for the various hardware components. TF-IDF methodologies are effective and processor non-intensive, making them well-suited when a single keyword within the user query input is most important to identifying a matching firmware or firmware or hardware capability for a hardware component to address the user’s concerns without engaging the OTB AI productivity tool at the OS level. For example, a user may provide a natural language user query input such as “get me through this meeting on battery power.” In such a case, it may be useful to perform a TF-IDF comparison across the stored natural language descriptions of the firmware or hardware capabilities within the library to identify the firmware or hardware capability that best addresses the specific term “battery power,” according to embodiments herein.

Execution of computer readable code instructions of the firmware-level AI productivity tool by a hardware controller such as an embedded controller in embodiments herein may perform such a lexical search comparing the natural language of the user query input to each of the firmware or hardware capability natural language descriptions stored within the natural language hardware capability library to generate, for each of these stored firmware or hardware capabilities, a lexical search similarity score. A highest lexical search similarity score generated in such a manner may be identified by the firmware-level AI productivity tool as a best match firmware or hardware capability for addressing the user query input. The firmware-level AI productivity tool in embodiments herein may then, independently of the operating system, instruct firmware for the hardware component associated with the best match firmware or hardware capability to perform the best match firmware or hardware capability for a responsive capability action at the firmware or hardware level, without engaging the OTB AI productivity tool at the OS level. In such a way, the embedded controller executing code instructions of the firmware-level AI productivity tool in embodiments herein may match the received user query inputs to known firmware or hardware capabilities of one or more hardware components through execution by the embedded controller of machine readable code instructions for one or more natural language processing machine learning models.

As described herein, a hardware processor executing code instructions of the OTB AI productivity tool at the OS level in embodiments herein may also match the same received user queries, or user query inputs, to known application capabilities of one or more of the AI productivity tool-enableable software applications through execution by the hardware processor of machine readable code instructions for one or more natural language processing machine learning models executing at the operating system, if also needed. The natural language processing machine learning (ML) models at the OS level may have similar but more robust operations than the natural language processing machine learning models executing at the firmware level via the firmware-level AI productivity tool. For example, the hardware processor executing code instructions of the OTB AI productivity tool in embodiments herein may also match the same received user query inputs to known application capabilities of one or more of the AI productivity tool-enableable software applications executing at the operating system level through execution by the hardware processor of machine readable code instructions for a semantic search methodology, rather than a lexical search methodology, or in tandem with a lexical search methodology. Lexical search methodologies such as that employed by the firmware-level AI productivity tool in embodiments lack the ability to determine context of the various keywords identified within the user query input. For example, TF-IDF methodologies cannot discern between different meanings for the same word or identify synonyms for keywords, which people routinely employ in natural language conversation. This may result in limits for matching between natural language text excerpts, such as the user query input and the software service or function described in a natural language capability for an AI productivity tool-enableable software application. In embodiments herein, a hardware processor may execute machine readable code instructions for a semantic similarity search machine learning model that analyzes and weighs context and relevancy to overcome this disadvantage of TF-IDF methodologies.

As a first step in such a semantic search methodology, a hardware processor executing machine readable code instructions for a capability intent value generator of the OTB AI productivity tool at the OS level may determine capability intent values associated with the natural language descriptions of the gathered application capabilities for each of a plurality of AI productivity tool-enablable software applications. These capability intent values are a mathematical representation of application capability operations or services from various AI productivity tool-enablable software applications in embodiments herein for use in semantic search similarity comparison methodologies. These capability intent values may be represented by a mathematical value in a multi-axis vector space that may be associated with a natural language description for that application capability. In an embodiment, the application capabilities may be associated with an identification (ID) such as an alphanumeric ID that also may be stored within a capability intent values database. Generating such capability intent values as vectors may be a first step in a natural language processing method to determine and correlate the user’s query intent or requested action within a user query input that takes into account the context or semantics of the words used within the user query input with one of a plurality of application capabilities.

Upon receipt of a user query input by the OTB AI productivity tool in embodiments herein, the received user query input data (audio, video or text) is routed to the embedded controller or other hardware controller at the client platform hardware or firmware level from the microphone, camera, keyboard, or other input. The embedded controller or other hardware controller will execute the firmware-level AI productivity tool to sniff or assess the incoming user query input data for keywords or key images (e.g., gestures) for matching to firmware or hardware level capabilities using lexical similarity determination for a user query intent and matching the user query intent to a library of available hardware or firmware capabilities according to embodiments herein.

The user query input data is also transferred to the OTB AI productivity tool executing at the operating system (OS) level at a hardware processor executing code instructions of a query intent determination module to determine a vectorized query input intent value for the user query input that may be comparable to the capability intent values for one or more AI productivity tool enablable software applications executing at the OS level for a responsive capability intent action to the user query input. The hardware processor executing machine readable code instructions for a query intent to capability determination module in embodiments herein may then compare the vectorized user query input intent value and the capability intent values stored within the capability intent values database. Such a comparison may be performed using a semantic search machine learning model, such as a cosine similarity search that compares the distance or value difference in a multi-axis vector space between two vectors (e.g., the capability intent value vector and the user query input value vector) to determine the contextual similarity between the natural language description of the capability and the natural language user query input. Such a contextual or semantic search methodology may take into account the fact that the same word may have two meanings or consider synonyms of words, for example.

This may be performed for several of the capability intent values stored within the capability intent value database to identify a capability intent value that most closely matches the user query input value. In such a way, a hardware processor executing code instructions for the query intent to capability module for the OTB AI productivity tool may take relevance and context of natural language within a user query input into account when determining a matching capability of an AI productivity tool enableable software application that is most likely to address the user’s intent within the user query input. The natural language application capability for an AI productivity tool enableable software application having the highest semantic similarity search score may then be identified, via execution of machine readable code instructions of the query intent to capability determination module by the hardware processor as the best match application capability most likely to address the user’s intended request within the natural language user query input. The OTB AI productivity tool in embodiments herein may then instruct the AI productivity tool-enableable software associated with the best match application capability to perform the best match application capability. This occurs in parallel, if needed, with any firmware or hardware capability actions triggered above by the embedded controller executing computer readable code instructions of the firmware-level AI productivity tool of embodiments herein. In such a way, the OTB AI productivity tool may implement a number of actions or utilizes services of various software applications based on the natural language of a received user query input and work in tandem with a firmware-level AI productivity tool to allow the same user queries to trigger certain plural actions declared and supported by firmware for various hardware components of the information handling system.

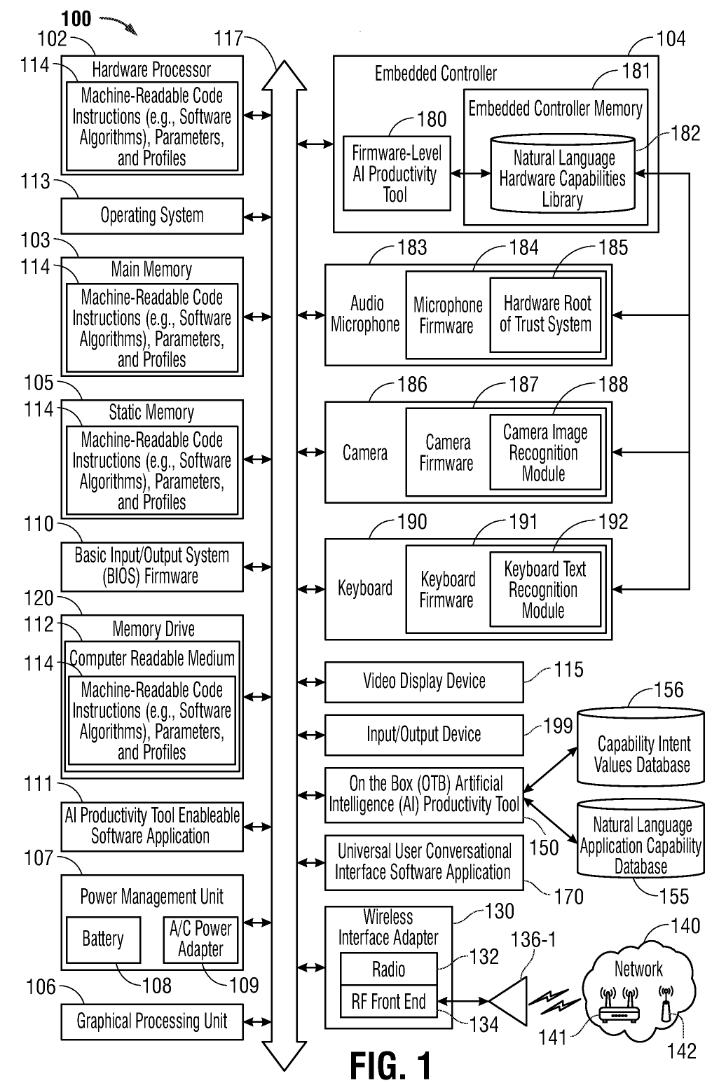

Turning now to the figures, FIG. 1 illustrates an information handling system 100 similar to the information handling systems according to several aspects of the present disclosure. As described herein, computer readable code instructions of an on the box (OTB) artificial intelligence (AI) productivity tool 150 may execute via hardware processor 102 at the operating system (OS) level 113 in an embodiment may implement a number of actions or utilizes services of various AI productivity tool enableable software applications 111 based on the natural language of a received user query input, and work in tandem with a firmware-level AI productivity tool 180 executing via an embedded controller 104 to allow the same user queries to trigger certain actions declared and supported by firmware (e.g., microphone firmware 184) for various hardware components (e.g., microphone 183) of the information handling system 100. In some embodiments, the user input queries may trigger actions supported by other firmware for other hardware components, such as the camera 186, keyboard 190, video display device 115 or the input/output device 199 directly via the firmware-level AI productivity tool 180 executing on embedded controller 104 or other hardware controller without any required OS level capability intent action response.

The OTB AI productivity tool 150 in an embodiment may receive, via microphone 183, camera 186, keyboard 190, or other input/output device 199, in combination with a universal user conversational interface software application 170, a user query input requesting that an action be taken at the information handling system 100. Such a universal user conversational interface software application 170 may operate separate and apart from the AI productivity tool enableable software application 111 or in connection with the same, and may service user query requests for actions to be taken by any number of a plurality of AI productivity tool enableable software applications 111. The firmware-level AI productivity tool 180 executing via an embedded controller 104 may receive user query input requests to determine certain responsive firmware or hardware capability actions declared and supported by firmware (e.g., microphone firmware 184) for various hardware components (e.g., microphone 183) of the information handling system 100 may be triggered in response by assessing the received user query input for keywords or key images (e.g., gestures) that match declared hardware or firmware capabilities at the firmware-level AI productivity tool 180. In parallel, computer readable code instructions of the OTB AI productivity tool 150 may operate to identify which of the plurality of AI productivity tool enableable software applications 111 may be capable of performing the action requested by the user within the user query input. Such a user query input may be made in voice format via the microphone 183, within an image captured via the camera 186, or in text format, for example, via the input/output device 199, or keyboard 190.

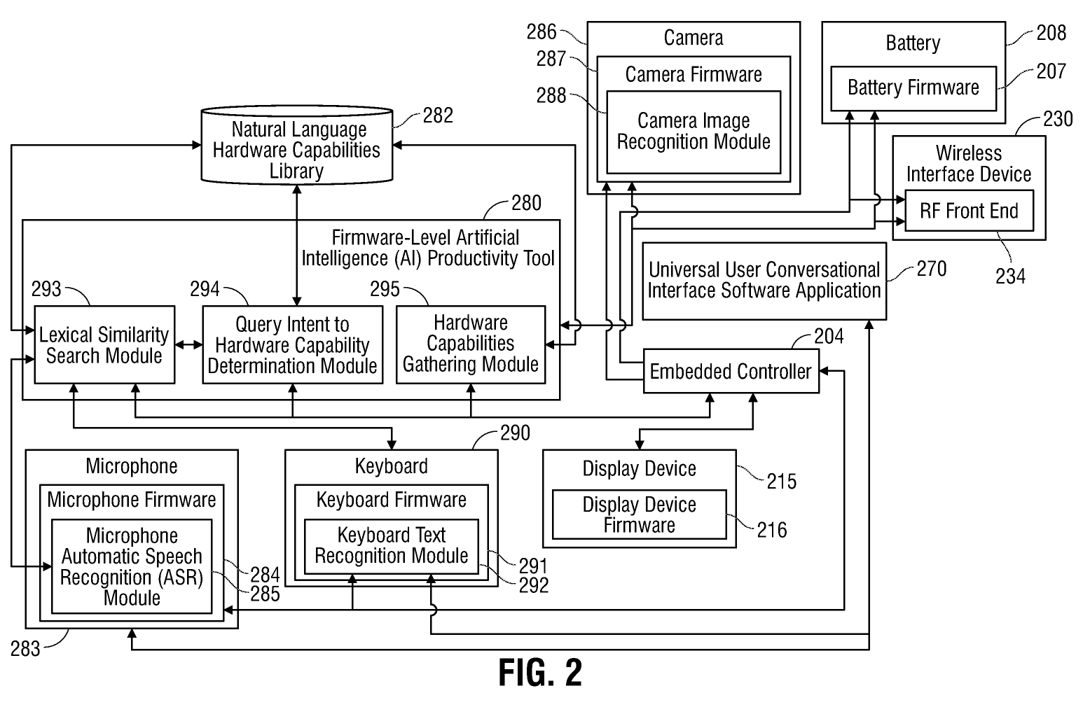

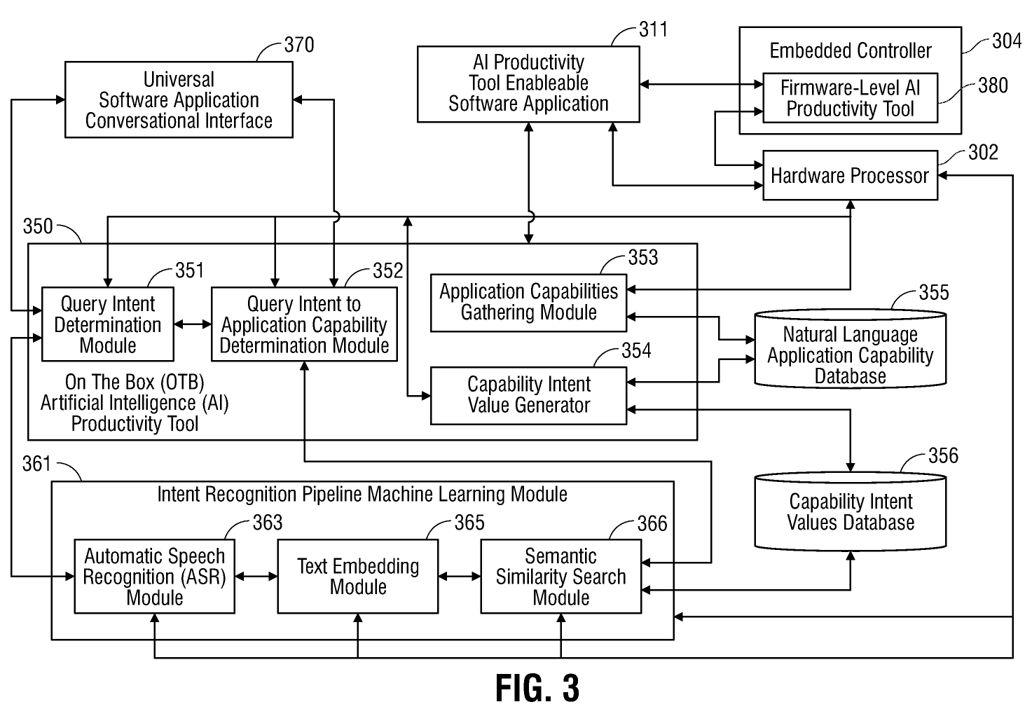

Upon receipt of the user query input via a hardware component, such as the microphone 183, camera 186, keyboard 190, or other input/output device 199, the firmware-level AI productivity tool 180 may operate at the firmware-level, separate and apart from the universal user conversational interface software application 170, to identify which of a plurality of hardware components (e.g., 183, 186, 108, 115, or 199) may be capable of performing the action requested by the user within the user query input. An embedded controller 104 executing code instructions of the firmware-level AI productivity tool 180 in an embodiment sniffs or searches these received user query inputs in audio, video, or text data formats. The embedded controller 104 may then search for keywords, use image recognition for key images, or use other techniques other to determine a match to known firmware or hardware capabilities of one or more hardware components, such as microphone 183, camera 186, display device 115, battery 108, or input/output devices 199 through execution by the embedded controller 104 of machine readable code instructions for one or more natural language processing machine learning models, as described in greater detail below with respect to FIG. 2. The known firmware or hardware capabilities of one or more hardware components on the information handling system 100 may be accessed at a natural language hardware capabilities library 182 that includes associated key words or key images or other identifiers of a set of hardware or firmware capabilities accessible at the information handling system platform level and not requiring software operation at the OS level. A hardware processor 102 executing code instructions of the OTB AI productivity tool 150 in an embodiment may receive the user query input data as well and match the same received user queries, or user query inputs to known application capabilities of one or more of the AI productivity tool-enableable software applications 111 through execution by the hardware processor 102 of machine readable code instructions for one or more natural language processing machine learning models executing at the operating system 113, as described in greater detail below with respect to FIG. 3, and having similar but more robust operations than the natural language processing machine learning models executing at the firmware level via the firmware-level AI productivity tool 180.

These processes include gathering, either in real-time or prior to execution of either the OTB AI productivity tool 150 or the firmware-level AI productivity tool 180, firmware or hardware capabilities for a plurality of hardware components (e.g., 102, 103, 115, 108, 183, 186, and 199) and application capabilities associated with each of a plurality of AI productivity tool-enablable software applications 111. For example, the firmware or hardware capabilities may be stored within the natural language hardware capabilities library 182 within memory 181 for the embedded controller, which may comprise flash read only memory (ROM). As another example, the application capabilities may be stored within the natural language software capabilities database 155. These firmware or hardware capabilities and application capabilities may describe those functionalities of each of the hardware components (e.g., 102, 103, 108, 115, 183, 186, and 199) and each of the AI productivity tool-enablable software applications 111, respectively, that may be used when interfacing with the OTB AI productivity tool 150 or the firmware-level AI productivity tool 180.

The natural language descriptions of the firmware or hardware capabilities for the hardware components (e.g., 102, 103, 108, 115, 183, 186, and 199) may be stored in natural language hardware capabilities library 182 for a lexical or keyword comparison, via the embedded controller 104, to received user query inputs, for example, in order to identify a firmware or hardware capability most likely to address a user’s request within the received user query inputs without elevating the user query input to the OTB AI productivity tool 150 executing at the OS level 113. For user query input data elevated to the OTB AI productivity tool 150 operating at the OS level, the natural language descriptions of the application capabilities for the AI productivity tool-enableable software applications 111 may be stored at the natural language application capabilities database 155 and an embedded capability intent values at the capabilities intent values database 156 for semantic comparison, via the hardware processor 102, to received user query inputs. This done at the OS level 113, for example, in order to identify an AI productivity tool enableable software application capability most likely to address a user’s request within the received user query inputs. Thus, the natural language descriptions of firmware or hardware capabilities stored within the natural language hardware capabilities library 182 may be condensed in comparison to the much larger database 155 of natural language descriptions of application capabilities stored in the natural language application capabilities database 155 and accessible by the main memory 103 when the OTB AI productivity tool 150 executes at the operating system level 113.

As described, the OTB AI productivity tool 150 executing at the operating system 113 level may perform a semantic comparison of the user query input and each of the stored natural language descriptions of the application capabilities to identify an application capability executable within an AI productivity tool-enableable software application 111 to perform a requested action by the operating system 113 within the user query input. In contrast, the firmware-level AI productivity tool 180 executing at the firmware level may perform a less complex and less processor-intensive lexical or keyword comparison of the user query input and each of the natural language descriptions of the firmware or hardware capabilities stored in the natural language hardware capabilities library 182 in embedded controller accessible memory 181 to identify a firmware or hardware capability executable within firmware (e.g., microphone firmware 184) for a specific hardware component (e.g., microphone 183) to perform a requested action within the user query input. Thus, the OTB AI productivity tool 150 executing in tandem with the firmware-level AI productivity tool 180 in embodiments herein may respond to a single user query input requesting that an action be taken, such as “optimize my system,” by performing an action, such as pausing execution of background software applications within an AI productivity tool-enableable software application 111 and by performing an action within firmware (e.g., power management unit 107) for a hardware components (e.g., battery 108), such as adjusting settings or functionality thereof (e.g., placing battery 108 in power save mode if battery power is low).

As described herein, the user may provide a user query input via an input device, such as the microphone 183, camera 186, keyboard 190, or other input device 199, which may be transmitted to the universal user conversational interface software application 170. In some embodiments, the universal user conversational interface software application 170 may forward this user query input to the OTB AI productivity tool 150, which may then forward the user query input to the firmware-level AI productivity tool 180 for identifying a firmware or hardware capability from the natural language hardware capability library 182 that may address the user query input. In other embodiments, firmware for the input device (e.g., microphone 183, camera 186, or keyboard 190) may transmit the received user query input directly to the firmware-level AI productivity tool 180 executing at embedded controller 104. Upon receipt of a user query input, or detection of receipt of such a user query input at firmware (e.g., microphone firmware 184, camera firmware 187, or keyboard firmware 191) for the microphone 183 or camera 186 in an embodiment, audio or image of the user query input may be translated to text or image recognition may be used via firmware of the microphone 183 or camera 186, respectively. For example, the microphone firmware 184 executing on an audio digital signal processing (DSP) hardware may execute a microphone automated speech recognition (ASR) module 185 to detect or spot words within the recorded voice data and generate text representing the detected words.

As another example, the camera firmware 187 may include an image recognition module 188 to translate captured images of the user into text or an identified image linked via a key image (e.g., a gesture) to a firmware or hardware capability action. In specific example embodiments, the image recognition module 188 may be capable of interpreting a captured image of a user with both palms up and facing the screen as the text or a key image for a firmware or hardware stop action to “stop,” or translating a series of captured images of a user swiping a hand past the lens as text or a key image for a firmware or hardware capability action to “move to next.” In other embodiments, the interpreted captures image of a user to text or as a key image may link to recognizing text within a captured image of an error message displayed on the display or on another device, or to translating various words and phrases from gestures or of known sign languages such as American Sign Language (ASL) or English Sign Language (ESL). In yet another example, the keyboard firmware 191 may execute a keyboard text recognition module 192 to detect or spot words within a series of received and registered keystrokes.

An embedded controller 104 executing code instructions of a lexical similarity search module of the firmware-level AI productivity tool 180 in an embodiment may then perform a lexical similarity search method to match the natural language text of the received user query input with a natural language description of a firmware or hardware capability stored in the natural language hardware capabilities library 182 in order to identify a firmware or hardware capability for hardware component (e.g., 102, 103, 108, 115, 183, 186, 199 or others) of the information handling system 100 that most closely corresponds and can address the user request within the user query input. A lexical similarity search methodology for matching text or documents in embodiments herein may center upon keyword searches, such as term frequency-inverse document frequency (TF-IDF) searches. TF-IDF searches in this context focus upon the frequency of a term or keyword found within a user query input and within known firmware or hardware capabilities for the various hardware components (e.g., 102, 103, 108, 115, 183, 186, 199 or others). TF-IDF methodologies are effective and processor non-intensive, making them well-suited when a single keyword within the user query input is sniffed or spotted in received user query input data by the DSP controller or embedded controller and is important to identifying a matching firmware or hardware capability for a hardware component (e.g., 102, 103, 108, 115, 183, 186, 199 or others) to address the user’s concerns or request in the received user query input. For example, a user may provide a natural language user query input such as “get me through this meeting on battery power.” In such a case, it may be useful to spot or identify the keyword “battery” or “power” and perform a TF-IDF comparison across the stored natural language descriptions of the firmware or hardware capabilities within the natural language hardware capability library 182 to identify the firmware or hardware capability that best addresses the specific term “battery power,” according to embodiments herein.

The firmware-level AI productivity tool 180 in an embodiment herein may perform such a lexical search comparing the natural language of the user query input to each of the firmware or hardware capability natural language descriptions stored within the natural language hardware capability library 182 to generate, for each of these stored firmware or hardware capabilities, a lexical search similarity score. A highest lexical search similarity score generated in such a manner may be identified by the firmware-level AI productivity tool 180 as a best match firmware or hardware capability for addressing the user query input. The firmware-level AI productivity tool 180 in an embodiment may then, independently of the operating system 113, instruct firmware (e.g., 107, 184, 187) for the hardware component (e.g., 108, 183, 186, respectively) associated with the best match firmware or hardware capability to perform the best match firmware or hardware capability. In such a way, the embedded controller 104 executing code instructions of the firmware-level AI productivity tool 180 in an embodiment may match the received user query inputs to known firmware or hardware capabilities of one or more hardware components (e.g., 102, 103, 108, 115, 183, 186, 199 or others) through execution by the embedded controller 104 of machine readable code instructions for one or more natural language processing machine learning models.

As described in some embodiments herein, a hardware processor 102 executing code instructions of the OTB AI productivity tool 150 at the OS level 113 in an embodiment may also match the same received user queries, or user query inputs in tandem to known application capabilities of one or more of the AI productivity tool-enableable software applications 111 through execution by the hardware processor 102 of machine readable code instructions for one or more natural language processing machine learning models executing at the operating system 113 and having similar but more robust operations than the natural language processing machine learning models executing at the firmware level via the firmware-level AI productivity tool 180. For example, the hardware processor 102 executing code instructions of the OTB AI productivity tool 150 in an embodiment may also match the same user query inputs received via the microphone 183, camera 186, or other input device 199 at the universal user conversational interface software application 170 to known application capabilities of one or more of the AI productivity tool-enableable software applications 111 executing at the operating system level through execution by the hardware processor 102 of machine readable code instructions for a semantic search methodology, rather than a lexical search methodology, or in tandem with a lexical search methodology. Lexical search methodologies such as that employed by the firmware-level AI productivity tool 180 in an embodiment lack the ability to determine context of the various keywords identified within the user query input. For example, TF-IDF methodologies cannot discern between different meanings for the same word or identify synonyms for keywords, which people routinely employ in natural language conversation. This may result in limits for matching between natural language text excerpts, such as the user query input and the software service or function described in a natural language capability for an AI productivity tool-enableable software application 111 and stored within the natural language application capability database 155. In an embodiment, a hardware processor 102 may execute machine readable code instructions for a semantic similarity search machine learning model that analyzes and weighs context and relevancy to overcome this disadvantage of TF-IDF methodologies.

As a first step in such a semantic search methodology, a hardware processor 102 executing machine readable code instructions for a capability intent value generator of the OTB AI productivity tool 150 may determine capability intent values associated with the natural language descriptions of the gathered application capabilities stored within the natural language application capability database 155 for each of a plurality of AI productivity tool-enablable software applications 111. For example, an AI productivity tool-enablable software application 111 may include a word processing application such as Microsoft ® Word ® that may receive input (e.g., via voice at a microphone 183 or text via a keyboard 190) and provide output via text. Still further, other examples of an AI productivity tool-enablable software application 111 may include an updating software, virus protection software, and setting optimization software such as Dell ® SupportAssist ® module executable by the hardware processor or other hardware processing resource of the information handling system. With SupportAssist ® a user may provide input via, for example, the microphone 183 requesting information related to a setting associated with hardware or software systems of the information handling system. Thus, capabilities of SupportAssist ® may include virus protection capabilities, setting manipulation capabilities, and software updating capabilities that may each be stored at the capability intent values database 156.

Even further, examples of an AI productivity tool-enablable software application 111 may include Dell ® Display ®/Peripheral Manager ®. The Dell ® Display ®/Peripheral Manager ® may have capabilities that include optimization of screen resolution, refresh rates, and gamma correction as well as webcam settings, mouse settings, keyboard settings, stylus settings, microphone settings, and trackpad settings, among other settings and connections associated with the wired or wireless input/output devices. Again, these capabilities associated with the execution of the Dell ® Display ®/Peripheral Manager ® software may have capability intent values derived from natural language descriptors of each of those capabilities and a capability identifier stored at the capability intent values database 156 as described herein. It is appreciated that the AI productivity tool-enablable software application 111 may include, for example, Dell ® Trusted Device ® software, a remediation Dell ® APEX Managed Device Service (AMDS) ® software, Alienware Command Center (AWCC) ® software, among others. Some AI productivity tool-enablable software applications 111 may even be subagents operating locally on the box of the information handling system 100, but have remote access to a larger software application executing at a cloud based server location for providing software services in some embodiments herein.

The capability intent values are a mathematical representation of application capability operations or services from various AI productivity tool-enablable software applications 111 in an embodiment for use in semantic search similarity comparison methodologies. These capability intent values may be represented by a mathematical value in a multi-axis vector space that may be associated with a natural language description for that application capability, as stored within the natural language application capability database 155. In an embodiment, the application capabilities stored within the natural language application capability database 155 may be associated with an identification (ID) such as an alphanumeric ID that also may be stored within a capability intent values database 156. Generating such capability intent values as vectors may be a first step in a semantic natural language processing method to determine and correlate the user’s query intent or requested action within a user query input that takes into account the context or semantics of the words used within the user query input with one of a plurality of application capabilities.

Upon receipt of a user query input by the OTB AI productivity tool 150 in an embodiment, a hardware processor 102 executing code instructions of a query intent determination module of the OTB AI productivity tool 150 may determine a vectorized query input intent value for the user query input that may be comparable to the capability intent values. The hardware processor 102 executing machine readable code instructions for a query intent to application capability determination module of the OTB AI productivity tool 150 in an embodiment may then compare the vectorized user query input intent value and the capability intent values stored within the capability intent values database 156. Such a comparison may be performed executing computer readable code instructions of a semantic search machine learning model, such as a cosine similarity search engine, that compares the distance or value difference in a multi-axis vector space between two vectors (e.g., the capability intent value vector and the user query input value vector) to determine the contextual similarity between the natural language description of the application capability and the natural language user query input. Such a contextual or semantic search engine may execute to take into account the fact that the same word may have two meanings or consider synonyms of words, for example.

Execution of computer readable code instructions of the query intent to application capability determination module may be performed for query intent values for several of the capability intent values stored within the capability intent value database 155 to identify a capability intent value that most closely matches the user query input value. In such a way, a hardware processor 102 executing code instructions for the query intent to application capability module for the OTB AI productivity tool 150 may take relevance and context of natural language within a user query input into account when determining a matching application capability of an AI productivity tool enableable software application 111 that is most likely to address the user’s intent within the user query input. The natural language application capability for an AI productivity tool enableable software application 111 having the highest semantic similarity search score may then be identified, via execution of machine readable code instructions of the query intent to application capability determination module of the OTB AI productivity tool 150 by the hardware processor 102 as the best match application capability most likely to address the user’s intended request within the natural language user query input. The OTB AI productivity tool 150 in an embodiment may then instruct the AI productivity tool-enableable software 111 associated with the best match application capability to execute the hardware processor 102 to perform the best match application capability. In such a way, the OTB AI productivity tool 150 may implement a number of actions or utilizes services of various software applications 111 based on the natural language of a received user query input and work in tandem with a firmware-level AI productivity tool 180 to allow the same user queries to trigger certain actions declared and supported by firmware (e.g., 107, 184, 187) for various hardware components (e.g., 102, 103, 108, 183, 186, 115, 199 or others) of the information handling system 100.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, other hardware controllers, or any combination thereof. Additional components of the information handling system 100 may include one or more storage devices such as static memory 105 or drive unit 120. The information handling system 100 may include or interface with one or more communications ports for communicating with external devices, as well as an input/output (IO) device 199, a video/graphics display device 115, an audio microphone 183 for recording user communications, or any combination thereof. Portions of an information handling system 100 may themselves be considered information handling systems 100.

Information handling system 100 may include devices or modules that embody one or more of the hardware devices or hardware processing resources executing machine readable code instructions for one or more systems and modules. The information handling system 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood any or all portions of machine readable code instructions (e.g., software or firmware algorithms), parameters, and profiles 114 may operate on a plurality of information handling systems 100. In a specific embodiment, machine readable code instructions for the OTB AI productivity tool 150, a universal user conversational interface software application software application 170, a firmware-level AI productivity tool 180, and one or more AI productivity tool enableable software applications 111 may execute locally at the information handling system 100, or on the box.

The information handling system 100 may include the hardware processor 102 such as a central processing unit (CPU) or other hardware processing resources. Any of the hardware processing resources may operate to execute machine readable code instructions 114 that are either firmware or software code. Moreover, the information handling system 100 may include memory such as main memory 103, static memory 105, and disk drive unit 120 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, EC 104, GPU 106, or any other hardware processing device. The information handling system 100 may also include one or more buses 117 operable to transmit communications between the various hardware components such as any combination of various I/O devices 199, 183, 186, as well as between hardware processors 102, an EC 104, GPU 106 or other, the operating system (OS) 111, the basic input/output system (BIOS) 110, the wireless interface adapter 130, or a radio module 132, among other components described herein. In an embodiment, the hardware processor 102, EC 104, and/or GPU 106 may execute one or more bus drivers in order to transmit this data between the information handling system 100 and the input/output devices 199 described herein. As described herein, the information handling system 100 further includes a video/graphics display device 115. The video/graphics display device 115 in an embodiment may function as a liquid crystal display (LCD), an organic light emitting diode (OLED), a flat panel display, or a solid-state display. It is appreciated that the video/graphics display device 115 may be wired or wireless and may be an external video/graphics display device 115 that allows a user to increase the desktop area by extending the desktop in an embodiment.

A network interface device of the information handling system 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system 100 to a network 140 via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system 100. Wireless interface adapter 130 may include one or more radio frequency (RF) subsystems (e.g., radio 132) with transmitter/receiver circuitry, modem circuitry, one or more antenna RF front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WiMAX, WWAN such as 3GPP or 3GPP2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHz, 5 GHz, or 6 GHz bands which may be shared communication frequency bands with WWAN protocols or Bluetooth ® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130.

The information handling system 100 may include a set of instructions 114 that may be executed to cause the computer system to perform any one or more of the methods or computer-based functions disclosed herein. For example, machine readable code instructions 114 may be executed by a hardware processor 102, GPU 106, EC 104 or any other hardware processing resource and may include software agents, or other aspects or components used to execute the methods and systems described herein. Various software modules comprising application machine readable code instructions 114 may be coordinated by an OS 113, and/or via an application programming interface (API) include a unified device API described herein. An example OS 113 may include Windows ®, Android ®, and other OS types. Example APIs may include Win 32, Core Java API, or Android APIs.

In an embodiment, the information handling system 100 may include a disk drive unit 120. The disk drive unit 120 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 120 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 120 during execution by the hardware processor 102, EC 104, or GPU 106 of information handling system 100.

Main memory 103 or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 120 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 107 (a.k.a. a power supply unit (PSU)). The PMU 107 may include a hardware controller and executable machine-readable code instructions to manage the power provided to the components of the information handling system 100 such as the hardware processor 102 and other hardware components described herein. The PMU 107 may control power to one or more components including the one or more drive units 120, the hardware processor 102 (e.g., CPU), the EC 104, the GPU 106, a video/graphic display device 115, or other wired I/O devices 183, 186, or 199 and other components that may require power when a power button has been actuated by a user. In an embodiment, the PMU 107 may monitor power levels and be electrically coupled to the information handling system 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 105 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel ® brand processor, AMD ® brand processors, Qualcomm ® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

FIG. 2 is a block diagram illustrating computer readable code instructions of a firmware-level artificial intelligence (AI) productivity tool executing at an embedded controller or other hardware controllers of an information handling system for spotting keywords or key images for correlating natural language of a user’s query input to a registered natural language description of a firmware or hardware capability for hardware component using a lexical similarity search according to an embodiment of the present disclosure. As described herein, Artificial intelligence (AI) is a developing technology that is used to increase efficiency of computing systems and interactions with humans. An example of AI technologies includes, but is not limited to, chat-enabled environments (voice, text, etc.). These chat-enabled environments are described in embodiments herein as an on the box (OTB) AI productivity tool that receives this voice or text input from a user and implements a number of actions or utilizes services of various software applications based on the natural language of the input. In some information handling systems, the OTB AI productivity tool may interface with various AI productivity tool-enablable software applications being executed or executable on the information handling system but may be processor intensive. These AI productivity tool-enablable software applications may integrate with the OTB AI productivity tool to allow user queries to trigger certain actions declared, supported, and managed by these AI productivity tool-enablable software applications. Further, in embodiments herein, the OTB AI productivity tool executing at the operating system level may work in tandem with an agent, referred to herein as a firmware-level AI productivity tool 280 executing at an embedded controller or other hardware controllers of an information handling system, to allow the same user queries to trigger certain actions declared and supported by firmware, such as microphone firmware 284, camera firmware 287, battery firmware 207, RF front end 234, or display device firmware 216 for various hardware components, such as a microphone 283, camera 286, battery 208, wireless interface device 230, or display device 215 of the information handling system. Thus, firmware-level AI productivity tool 280 provides for expedient access, with low compute requirements, to conduct responsive hardware or firmware capability actions to enhance or even replace operating system (OS) level capability action responses from an OTB AI productivity tool operating at an OS level and to scale responses to received user query inputs with additional hardware and firmware responsive capabilities.

The universal user conversational interface software application 270 in an embodiment may receive a user query input requesting that an action be taken at the information handling system. Such a user query input may be made in voice format via the microphone 283, within an image captured via the camera 286, or in text format, for example, via the keyboard 290. Upon receipt of the user query input via a hardware component, such as the microphone 283, camera 286, keyboard 290, or other input/output devices, the firmware-level AI productivity tool 280 may operate at the firmware-level, separate and apart from the universal user conversational interface software application 270 (which may operate at the operating system level) to identify which of the plurality of hardware components (e.g., 208, 215, 230, 283, 286, 290 or other input/output components or other firmware at an information handling system platform level, such as those described at 199 in FIG. 1) may be capable of performing the action requested by the user within the user query input to enhance responsive capability actions available from firmware or hardware.

An embedded controller 204 executing code instructions of the firmware-level AI productivity tool 280 in an embodiment may match these received user queries, or user query inputs from the microphone 283, camera 286, and keyboard 290 to known firmware or hardware capabilities of one or more hardware components, such as battery 208, display device 215, microphone 283, camera 286, keyboard 290, or other hardware components (e.g., input/output devices 199 of FIG. 1). Execution of code instructions of the firmware-level AI productivity tool 280 may spot a keyword or keywords or key image in user query input data through execution by the embedded controller 204 of machine readable code instructions for one or more natural language processing machine learning models having scaled down processing requirements and compare those lexical or image recognition results with published platform level hardware or firmware capabilities from a natural language hardware capabilities library database 282 accessible by an embedded controller 270.

One example natural language processing machine learning model process having scaled down processing requirements includes gathering firmware or hardware capabilities for a plurality of hardware components, via the embedded controller 204 executing machine readable code instructions of the firmware or hardware capabilities gathering module 295 of the firmware-level AI productivity tool 280 in an embodiment. Gathering firmware or hardware capabilities for a plurality of hardware components (e.g., 208, 215, 230, 283, 286, or 290) may occur either in real-time or prior to execution of the firmware-level AI productivity tool 280 to spot keywords or identify key images in received a user query input video or audio data. For example, the firmware or hardware capabilities may be stored within the natural language hardware capabilities library 282 within memory accessible to the embedded controller 204. These firmware or hardware capabilities may describe functionalities of each of the hardware components (e.g., 208, 215, 230, 283, 286, and 290) that may be used when interfacing with the firmware-level AI productivity tool 280. More specifically, the firmware or hardware capabilities stored within the natural language hardware capabilities library 282 may describe functionalities of the battery 208, such as various power mode settings including power saving mode and having associated keywords or even key images. As another example, the firmware or hardware capabilities stored within the natural language hardware capabilities library 282 may describe functionalities of a wireless interface adapter 230, such as selection between a plurality of available wireless communication protocols (e.g., WWAN, WLAN, WPAN) and include associated keywords or even key images. As yet another example, the firmware or hardware capabilities may be stored within the natural language hardware capabilities library 282 may describe functionalities of the digital display 215, such as various digital display parameters (e.g., resolution, frame rate, contrast, brightness), or various modes (e.g., power save mode, night mode, day mode, movie mode, game mode) and include associated keywords or even key images.

The natural language descriptions of the firmware or hardware capabilities for the hardware components (e.g., 208, 215, 230, 283, 286, and 290) including associated keywords or even key images may be stored for a lexical or keyword comparison to received user query inputs via the embedded controller 204 or other hardware controller such as an audio digital signal processing (DSP) controller, video camera controller, or a keyboard controller for example. Comparison by execution of computer readable code instructions of the firmware-level AI productivity tool may be a lexical comparison or image recognition comparison in order to identify keywords or key images for corresponding firmware or hardware capabilities in the natural language hardware capabilities library database 282 most likely to address a user’s request via execution at the information handling system platform level responsive to the received user query inputs. These natural language descriptions of firmware or hardware capabilities stored within the natural language hardware capabilities library 282 may be condensed in comparison to the much larger database of natural language descriptions of software application capabilities stored in the main memory and executable at the operating system level via the OTB AI productivity tool described in greater detail below with respect to FIG. 3. These firmware or hardware capabilities may be limited in number and be specific to information handling system platform-level hardware and firmware capabilities that are controlled at the information handling system platform level below the operating system (OS). Storage and access of these firmware or hardware capabilities, and their execution at the platform level allows for scaling and expansion of available responsive capabilities to include these platform level firmware or hardware responsive capability actions without additional burden to the processing intensive OTB AI productivity tool executing at the operating system level via a hardware processor such as the CPU.

The OTB AI productivity tool described with respect to FIG. 3 executing at the operating system level may perform in tandem a semantic comparison of the user query input and each of the stored natural language descriptions of the various AI productivity tool enableable software application capabilities according to embodiments herein. In contrast, the firmware-level AI productivity tool 280 executing at the firmware level may perform a less complex and less processor-intensive lexical or keyword comparison of the user query input and each of the natural language descriptions of the firmware or hardware capabilities stored in the natural language hardware capabilities library 282 to identify a firmware or hardware capability executable within firmware 207, 216, 234, 284, or 287 for a specific hardware component 208, 215, 230, 283, or 286, respectively, to perform a requested action within the user query input. Thus, expanded hardware or software capabilities may be available to be invoked without additional size or processing burden at the OTB AI productivity tool or the hardware processor (CPU) at the OS level. Thus, the OTB AI productivity tool described with reference to FIG. 3 below, executing in tandem with the firmware-level AI productivity tool 280 in an embodiment may respond to a single user query input requesting that an action be taken, such as “optimize my system,” by performing an action, such as pausing execution of background software applications within an AI productivity tool-enableable software application (as described in greater detail below with respect to FIG. 3) and by performing an action within firmware 207, 216, 234, 284, or 287 for a hardware component 208, 215, 230, 283, 286, or 290 respectively, such as adjusting settings or functionality thereof (e.g., placing battery 208 in power save mode) with less impact on the CPU and OTB AI productivity tool.

As described herein, the user may provide a user query input via an input device, such as the microphone 283, camera 286, keyboard 290 or other input device (e.g., 199 of FIG. 1), which may be transmitted to the universal user conversational interface software application 270. Firmware 284287, or 291 for the receiving input device, such as the microphone 281, the camera 286, or the keyboard 290 respectively, may translate a user query input to text, image or other and transmit the text user query input directly to the firmware-level AI productivity tool 280 executing at an embedded controller 204 or other hardware controllers at the information handling system platform level. Upon detection of receipt of such a user query input at firmware (e.g., microphone firmware 284, camera firmware 287, or keyboard firmware 291) for the microphone 283, camera 286, or keyboard 290 in an embodiment, audio, image, or text of the user query input may be translated to text for detection of keywords or images for image detection of key images via firmware of the microphone 283 or camera 286, respectively. For example, the microphone firmware 284 may include a microphone automated speech recognition (ASR) module 285 to detect or spot words within the recorded voice data and generate text representing the detected words which may be keywords. As another example, the camera firmware 287 may include an image recognition module 288 to translate captured images of the user into text or use image recognition of key images (and image parameters). More specifically, the image recognition module 288 may be capable of interpreting a captured image of a user with both palms up and facing the screen as the text “stop,” or a key image indicating a stop gesture, translating a captured image of a user swiping a hand past the lens as “move to next,” or translating various gestures or words and phrases of known sign languages such as American Sign Language (ASL) or English Sign Language (ESL) as key images for gesture detection. As yet another example, the keyboard firmware 291 may include a keyboard text recognition module 292 to detect or spot words within received or detected keystrokes representing the detected words which may be keywords.

An embedded controller 204 executing code instructions of a lexical similarity search module of the firmware-level AI productivity tool 280 in an embodiment may then perform a lexical similarity search method to match the natural language text of the received user query input with a natural language description or match a key image with a gesture of a firmware or hardware capability stored in the natural language hardware capabilities library 282 in order to identify a firmware or hardware capability for hardware component (e.g., 208, 215, 230, 283, 286, or 290) of the information handling system that most closely corresponds and can address the user request within the user query input. A lexical similarity search methodology for matching text or documents in embodiments herein may center upon keyword searches, such as term frequency-inverse document frequency (TF-IDF) searches in one embodiment. TF-IDF searches in this context focus upon the frequency of a term or keyword found within a user query input and within known firmware or hardware capabilities for the various hardware components (e.g., 208, 215, 230, 283, 286, or 290). TF-IDF methodologies are effective and processor non-intensive, making them well-suited when a single keyword within the user query input is most important to identifying a matching firmware or hardware capability for a hardware component (e.g., 208, 215, 230, 283, 286, or 290) to address the user’s concerns.

In an example embodiment, the embedded controller 204 executing code instructions for the lexical similarity search module 293 may perform a TF-IDF algorithm to measure the frequency with which each of a plurality of natural language terms appear within the user query input, as weighted by the frequency with which that term occurs in one of each of the natural language firmware or hardware capabilities stored within the natural language hardware capability library 282. More specifically, the hardware processor executing code instructions for a TF-IDF algorithm may determine a TF-IDF similarity score measuring the frequency with which each of a plurality of natural language terms, including names of various hardware components (e.g., 208, 215, 230, 283, 286, or 290) or terms appearing in adjustable settings or policies for those hardware components appear in the user query input, as weighted by the frequency with which each of those terms also occur within each of the natural language hardware capabilities stored at the natural language capabilities library 282. This comparison may be repeated for each of the firmware or hardware capabilities stored within the natural language hardware capability library 282, to produce a lexical similarity search score for each of the firmware or hardware capabilities to one or more keywords detected in the user query input data. Each TF-IDF similarity score determined in such a way may have a value between zero and one. Thus, if there is a TF-IDF match between a term in a natural language description of a firmware or hardware capability, that firmware or hardware capability will have an increased weighting for a match over other firmware or hardware capabilities that do not contain this term in embodiments herein. Further, if there are multiple TF-IDF matches between a plurality of terms in a natural language description of a firmware or hardware capability, that firmware or hardware capability will have an increased weighting for a match over other firmware or hardware capabilities that only contain one matching term in embodiments herein. It is contemplated that any number of known or later-developed TF-IDF comparison algorithms may be used, including the best-match 25 (BM25) algorithm, the Okapi BM25 algorithm, and the BM-25 with fields (BM-25F).

As described herein, the embedded controller 204 executing code instructions for the lexical similarity search module 293 may perform a TF-IDF algorithm to measure the frequency with which each of a plurality of natural language terms of spotted keywords appear within the user query input, as weighted by the frequency with which that term occurs in one of each of the natural language firmware or hardware capabilities stored within the natural language hardware capability library 282. For example, a user may provide a natural language user query input such as “get me through this meeting on battery power.” In such a scenario, the embedded controller 204 executing code instructions for the lexical similarity search module 293 may determine that firmware or hardware capabilities stored within the natural language hardware capability library 282 such as “place battery in power save mode,” “reduce camera frame capture rate,” “turn off audio codecs,” “turn off Bluetooth ®,” or “reduce display resolution,” have non-zero lexical similarity search scores.

In another example embodiment, the embedded controller 204 executing code instructions for the camera image recognition module 288 may perform an image recognition algorithm or use a convolutional neural network, thar may be a trained neural network, to identify one or more parameters, features, identified objects, edges, or patterns within images captured by the camera 286 correlating to parameters, features, identified objects, edges, or patterns within key images stored in the natural language hardware capabilities library 282 to represent one or more hardware or firmware capabilities. The image recognition algorithm trained neural network may be of limited scope for a discrete set of images to be recognized for execution on the embedded controller 204 in an embodiment. More specifically, the camera 286 may capture one or more images of a user showing palms in a gesture for “stop.” In such a scenario, the embedded controller 204 executing code instructions for the camera image recognition module 288 may determine that firmware or hardware capabilities stored within the natural language hardware capability library 282 such as a key image for a gesture to “stop charging battery,” have non-zero lexical similarity search scores or lexical search scores that above a threshold indicating sufficient correlation of the captured image in a user query input and the key image.

In some embodiments, the embedded controller 204 may execute code instructions for the query intent to firmware or hardware capabilities determination module 294 to identify all firmware or hardware capabilities associated with a lexical similarity search score or image recognition gesture correlation lexical score above a threshold value (e.g., 0.05. 0.1, 0.2) as best match firmware or hardware capabilities for execution at firmware (e.g., 207, 216, 234, 284, 287, 291) in response to the received user query input. In other embodiments, the embedded controller 204 may execute code instructions for the query intent to firmware or hardware capabilities determination module 294 to identify a single firmware or hardware capability associated with a highest lexical similarity search score or image recognition association in comparison to lexical similarity search scores or image gesture associated for all other firmware or hardware capabilities stored within the natural language hardware capability library 282 as best match firmware or hardware capabilities for execution at firmware (e.g., 207, 216, 234, 284, 287) in response to the received user query input. The firmware-level AI productivity tool 280 in an embodiment may then, independently of the operating system, instruct firmware (e.g., 207, 216, 234, 284, 287) for the hardware component (e.g., 208, 215, 230, 283, 286, 290 respectively) associated with the best match firmware or hardware capability to perform the best match firmware or hardware capability in response to a received user query input.

For example, in an embodiment in which the embedded controller 204 executing code instructions for the lexical similarity search module 293 determines that the firmware or hardware capability “place battery in power save mode” is a best match firmware or hardware capability, the embedded controller 204 may instruct battery firmware 207 to place the battery in a preset power save mode to conserve power. In another example, in an embodiment in which the embedded controller 204 executing code instructions for the lexical similarity search module 293 determines that the firmware or hardware capability “reduce camera frame capture rate” is a best match firmware or hardware capability, the embedded controller 204 may instruct the camera firmware 287 to reduce the frame capture rate for the camera. In still another example, in an embodiment in which the embedded controller 204 executing code instructions for the lexical similarity search module 293 determines that the firmware or hardware capability “turn off audio codecs” is a best match firmware or hardware capability, the embedded controller 204 may instruct the microphone firmware 284 to disable audio codec processing on incoming audio. As yet another example, in an embodiment in which the embedded controller 204 executing code instructions for the lexical similarity search module 293 determines that the firmware or hardware capability “turn off Bluetooth ®” is a best match firmware or hardware capability, the embedded controller 204 may instruct the RF front end 234 to turn off a Bluetooth ® radio or antenna and rely solely on Wi-Fi (WLAN) or cellular (WWAN) signals. In still another example, in an embodiment in which the embedded controller 204 executing code instructions for the lexical similarity search module 293 determines that the firmware or hardware capability “reduce display resolution” is a best match firmware or hardware capability, the embedded controller 204 may instruct the display device firmware 216 to decrease the display resolution from high-definition to standard definition.

Another example of a firmware or hardware capability includes platform level control to decrease a display resolution for a display device 215 from high-definition to standard definition via instructions executed at the information handling system platform level. Other examples of firmware or hardware capabilities include platform level control, via instructions executed at the information handling system platform level, to reduce a frame capture rate for camera 286, to disable audio codec processing on incoming audio received via the microphone 283, to turn off a Bluetooth ® radio or antenna of a wireless network interface device 230, or to alter settings of other hardware components in various embodiments herein.

In such a way, the embedded controller 204 executing code instructions of the firmware-level AI productivity tool 280 in an embodiment may match the received user query inputs to known firmware or hardware capabilities of one or more hardware components (e.g., 208, 215, 230, 283, 286, 290) through execution by the embedded controller 204 of machine readable code instructions for the firmware-level AI productivity tool 280 to expand responsive capability actions into information handling system platform level capabilities without additional size or computational burden on an OTB AI productivity tool executing at the information handling system by a hardware processor (e.g., CPU) at the OS level.

FIG. 3 is a block diagram illustrating computer readable code instructions of an on the box (OTB) artificial intelligence (AI) productivity tool executed by a hardware processor to instruct an AI productivity tool enableable software application to perform an application capability having a vectorized capability intent value from natural language processing (NLP) correlating to a vectorized query input intent value for a received user query input according to an embodiment of the present disclosure. The AI productivity tool enableable software application 311 in an embodiment may then execute a responsive capability for operations, software services, or generating a response to meet the chatbot input query. As described herein, a hardware processor 302 executing code instructions of the OTB AI productivity tool 350 in an embodiment may match the same user query input received and processed at the firmware level, as described above with respect to FIG. 2, to known application capabilities of one or more of the AI productivity tool-enableable software applications 311 through execution by the hardware processor 302 of machine readable code instructions for one or more natural language processing machine learning models executing at the operating system and having similar but more robust operations than the natural language processing machine learning models executing at the firmware level via the firmware-level AI productivity tool 380. For example, the hardware processor 302 executing code instructions of the OTB AI productivity tool 350 in an embodiment may also match the same user query inputs received via the microphone (283 of FIG. 2), camera (286 of FIG. 2), or other input device (199 of FIG. 1) at the universal user conversational interface software application 370 to known application capabilities of one or more of the AI productivity tool-enableable software applications 311 executing at the operating system level through execution by the hardware processor 302 of machine readable code instructions for a semantic search methodology, rather than a lexical search methodology, or in tandem with a lexical search methodology.

Lexical search methodologies such as that employed by the firmware-level AI productivity tool 380 in an embodiment lack the ability to determine context of the various keywords identified within the user query input. For example, TF-IDF methodologies cannot discern between different meanings for the same word or identify synonyms for keywords, which people routinely employ in natural language conversation. This may result in limits for matching between natural language text excerpts, such as the user query input and the software service or function described in a natural language application capability for an AI productivity tool-enableable software application 311 and stored within the natural language application capability database 355. In an embodiment, a hardware processor 302 may execute machine readable code instructions for a semantic similarity search machine learning model that analyzes and weighs context and relevancy to overcome this disadvantage of TF-IDF methodologies.

The OTB AI productivity tool 350 in an embodiment may receive, via a universal user conversational interface software application 370 or other interface, a voice, image, or text input from a user, described herein as a user query input, that requests actions or services of various software applications in natural language. A hardware processor 302 executing code instructions of the OTB AI productivity tool 350 in an embodiment may match these received user queries, or user query inputs to known application capabilities of one or more of the AI productivity tool-enableable software applications 311 through execution by the hardware processor 302 of machine readable code instructions for one or more natural language processing machine learning models. AI productivity tool enableable software application 311 may have or publish a list of recognized application capabilities or functionalities that it may perform during execution of such an AI productivity tool enableable software application 311 in response to a query input received and processed by the OTB AI productivity tool 350, a query intent determination module 351 and text embedding machine learning module 365 into a query intent vector value. The capabilities are provided text descriptors that may be processed into vectorized capability intent values in a multi-axis vector space such that these intent value mathematical representations of a query and a capability may be correlated by a similarity matching algorithm to select a capability responsive to an input query from a user.

This process includes gathering, either in real-time or prior to execution of the OTB AI productivity tool 350, via the capabilities gathering module 353, application capabilities associated with each of a plurality of AI productivity tool-enablable software applications 311. These application capabilities (also called application capability intents and having capability intent values) may describe those functionalities of each of the AI productivity tool-enablable software applications 311 that may be used when interfacing with the OTB AI productivity tool 350. These natural language descriptions of the application capabilities for the AI productivity tool-enableable software applications 311 may be stored within a natural language application capability database 355 for comparison to received user query inputs, for example, in order to identify an application capability most likely to address a user’s request within the received user query inputs.

The hardware processor 302 executing machine readable code instructions of the OTB AI productivity tool 350 may determine capability intent values associated with natural language descriptions of the gathered application capabilities for each of a plurality of AI productivity tool-enablable software applications 311. In an embodiment, these capability intent values are a mathematical representation of the natural language descriptions of capability operations or services from various AI productivity tool-enablable software applications 311 in an embodiment. These capability intent values may be represented by a mathematical value in a multi-axis vector space that may be associated with the natural language description for that application capability or intent. In an embodiment, the application capabilities may also be associated with an identification (ID) such as an alphanumeric ID that may be stored within a capability intent values database 356. Generating such capability intent values as vectors may be a first step in a natural language processing method to determine an application capability corresponding to and responsive to the user’s intent or requested action within a user query input that takes into account the context or semantics of the words used within the user query input.

In an embodiment, the capability intent values database 356 may store a plurality of application capabilities associated with each of a plurality of AI productivity tool-enablable software applications 311 with a name, application capability ID, natural language descriptor, or a capability intent value in some embodiments. These application capabilities stored at the capability intent values database 356 may include any input and output capabilities provided by the AI productivity tool-enablable software applications 311 being executed by the hardware processor 302 or any other hardware processing devices, such as embedded controller 304. For example, an AI productivity tool-enablable software application 311 may include a word processing application such as Microsoft ® Word ® that may receive input (e.g., via voice at a microphone 183 or text via a keyboard 190 of FIG. 1) and provide output via text. Still further, other examples of an AI productivity tool-enablable software application 311 may include an updating software, virus protection software, and setting optimization software such as Dell ® SupportAssist ® module executable by the hardware processor or other hardware processing resource of the information handling system. With SupportAssist ® a user may provide input via, for example, the microphone requesting information related to a setting associated with the information handling system. Thus, capabilities of SupportAssist ® may include virus protection capabilities, setting manipulation capabilities, and software updating capabilities that may each be stored at the capability intent values database 356.

Even further, examples of an AI productivity tool-enablable software application 311 may include Dell ® Display ®/Peripheral Manager ®. The Dell ® Display ®/Peripheral Manager ® may have application capabilities that include optimization of screen resolution, refresh rates, and gamma correction as well as webcam settings, mouse settings, keyboard settings, stylus settings, microphone settings, and trackpad settings, among other settings and connections associated with the wired or wireless input/output devices. Again, these application capabilities associated with the execution of the Dell ® Display ®/Peripheral Manager ® software may have capability intent values and an application capability identifier stored at the capability intent values database 356 as described herein. It is appreciated that the AI productivity tool-enablable software application 311 may include, for example, Dell ® Trusted Device ® software, a remediation Dell ® APEX Managed Device Service (AMDS) ® software, Alienware Command Center (AWCC) ® software, among others. Some AI productivity tool-enablable software applications 311 may even be subagents operating locally on the box of the information handling system but have remote access to a larger software application executing at a cloud based server location for providing software services in some embodiments herein.

The application capabilities may be registered with the OTB AI productivity tool 350 in an embodiment for establishing capability intent values for these capabilities such that chat user query input intent values may be correlated with one or more capability intent values for registered capabilities, as described herein. For example, in an embodiment in which the AI productivity tool enableable software application 311 is a software application for optimizing performance of hardware components at the information handling system, such capabilities may include adjusting settings or configurations for various hardware components. As another example, in an embodiment in which the AI productivity tool enableable software application 311 optimizes performance of other software applications, such capabilities may include automatically downloading and installing updates for such AI productivity tool enableable software applications 311, or pausing execution of background applications. In yet another example, in an embodiment in which the AI productivity tool enableable software application 311 is one of several software applications routinely executing on the information handling system, and optimized by such an OTB AI productivity tool 350, such capabilities may include automatically generating and transmitting e-mails or text messages, automatically scheduling meetings, or generating chatbot or other user interface responses.

Each of the application capabilities stored at the capability intent values database 356 may have a description with text descriptors, may be associated with a unique ID, and may have a capability intent value in an embodiment. Upon registration of a given application capability by the AI productivity tool enableable software application 311 in an embodiment, a hardware processor 302 for the information handling system may execute machine readable code instructions for one or more text embedding algorithms to generate a multi-dimensional vector capability intent value for that application capability that, for example, may be based on text descriptors for that application capability. Each of these capability intent values for association with these capabilities may also be associated with an ID such as an alphanumeric ID that may identify, uniquely, these application capabilities in the capability intent values database 356, for example. These capability intent values may later be used to determine which of the capabilities a user intends to invoke or execute within a received user query input based on similarity with a query intent value, as described herein.

As described above, the capability intent values for natural language descriptions of application capabilities for an AI productivity tool enableable software application 311 are a vectorized mathematical representation in a multi-axis vector space of the natural language descriptions of application capability operations or services from various AI productivity tool-enablable software applications 311 in an embodiment, as generated using natural language processing (NLP) techniques via execution of machine readable code instructions by the hardware processor 302 of the query intent determination module 351 and the text embedding module 365. Each axis of the multi-axis vector space may provide a measurement of various attributes of a text excerpt that are known to provide context or semantic understanding of the text. For example, one or more axis values may represent a reader’s understanding of a given text excerpt may depend upon the reader’s knowledge of any given word’s meaning within the text, identified phrases within the text, or the understood order or sequence of words within the text. More specifically, one or more axis values may represent the reader’s understanding as enhanced with a larger vocabulary and assigned values for which words in that vocabulary are synonyms (closer in meaning) to a given word in that text, and which words are antonyms (further away in meaning) to that given word. As another example, one or more axis values may represent the reader’s ability to identify common phrases, such as “in other words” may provide greater insight to the semantic meaning of a text excerpt using this phrase than an understanding of each of the words “in,” “other,” and “words” used separately from one another would. As yet another example, one or more axis values may represent the importance of the order of certain words in an excerpt may impact semantic meaning of the excerpt. More specifically, the phrase “man bites dog” may have a completely different semantic or contextual meaning than the phrase “dog bites man,” although each phrase has the same words, just in a different order.

Each axis of the multi-axis vector space, and thus, each value within a vector within such a multi-axis vector space may provide a measurement of these various attributes within a given initial or updated capability intent value in embodiments herein. Hundreds of vector axes may be the basis for the intent vector value in a multi-dimensional “space.” For example, a vector for a user query input intent value or for capability intent value may provide a measurement of similarity between any given word within the user query input or AI productivity tool enablable software application 311 capabilities, respectively, a measurement of dissimilarity with known antonyms, identification of any given word as part of a phrase, or usage of any given word in a specific order that is known to be of importance. In such a way, the vectorized user query input intent value and capability intent values may mathematically represent a reader’s contextual or semantic understanding of the user query input and the natural language descriptors for the capabilities of the AI productivity tool enableable software applications 311. These vectors may then be compared to one another, via the hardware processor 302 executing machine readable code instructions of the semantic similarity search module 366 to determine statistical correlation, in order to understand how alike various phrases within the user query input and capabilities are, and how alike the usage of those words and phrases are to provide a context, such as influenced by the order of those words or phrases and their relation to one another, as well as other semantic factors represented in the multi-axis vector space.

The hardware processor 302 may also execute machine readable code instructions of a text embedding module 365 to detect which of these words are nouns, verbs, or commonly used sentence structures and generate a vectorized query input intent value for the user query input. These vectorized capability intent values and vectorized query input intent values may then be compared to one another, via the hardware processor 302 executing machine readable code instructions of the semantic similarity search module 366, in order to determine a statistical correlation that represents understanding how alike various phrases within the user query input and capabilities are, and how alike the usage of those words and phrases are to provide a context, such as influenced by the order of those words or phrases and their relation to one another. For example, the hardware processor 302 executing machine readable code instructions of the semantic similarity search module 366, and in some embodiments in tandem with algorithms of the text embedding module 365 may compare the vectorized query input intent value with the capability intent values stored within the capability intent value database 354 to identify a capability intent value correlated to the query input intent value, indicating that the user query input is requesting that the AI productivity tool enableable software application 311 execute the application capability associated with that capability intent value. Such a comparison, in an embodiment, may include, for example, determining a distance or a vector value difference between the vectorized query input intent value and the vectorized capability intent value or a correlation value between the two. Examples of semantic similarity search module 366 algorithms may include, for example, a Cosine Similarity search machine learning model, a vector space model (VSM) similarity search machine learning model, or a K-Means Text Clustering similarity search machine learning model. These are only a few examples of semantic similarity search algorithms that may be employed and it is contemplated that any known or later-developed semantic similarity search algorithm may also be employed.

Upon determination of a capability intent value for each of the gathered or registered AI productivity tool enableable software application capabilities, the OTB AI productivity tool 350 may begin processing received user query inputs from the universal conversational interface software application 370 or other interface for execution of capabilities for an application software service, response or other function corresponding to one of these capability intent values. In an example embodiment, a user may provide a user query input in the form of text or voice data (e.g., via IO device 199, keyboard 190, microphone 183, or camera 186 of FIG. 1) to a universal user conversational interface software application 370, executing machine readable code instructions as a chatbot with the OTB AI productivity tool 350 to simulate a conversation between the user and the AI productivity tool enableable software application 311. When a user provides a user query input in the form of text or voice data (e.g., via IO device 199, keyboard 190, microphone 183, or camera 186 of FIG. 1) to the universal user conversational interface software application 370, the hardware processor 302 executing machine-readable code instructions of the OTB AI productivity tool 350 in an embodiment may orchestrate assessment of the user’s intended goals within the user query input (e.g., what the user wishes to achieve with this communication) with determination of a query input intent value, and identify one or more capabilities associated with the AI productivity tool enableable software application 311 having a correlating capability intent value and that is capable of executing a response to this user query input intent. Further, the OTB AI productivity tool 350 may initiate performance of one or more tasks employing those capabilities to achieve the user-intended results to the user query input.

This orchestration in an embodiment may begin with the hardware processor 302 executing machine-readable code instructions of the query intent determination module 351 to receive the user query input via microphone, image, or text input, and initiate execution of machine readable code instructions for an intent recognition pipeline machine learning module 361. In an embodiment, the hardware processor 302 executing machine-readable code instructions for the intent recognition pipeline machine learning module 361 may further orchestrate any combination of a plurality of machine learning modules (e.g., 363, 365, or 366) to process the audio, image, or text input to determine the user’s intended goal or query intent within the received text or voice data of the user query input. During operation for example, the hardware processor 302 executing machine-readable code instructions of the query intent determination module 351 may load one or more machine learning models such that, for example, the text or voice input from the user may be processed through a speech recognition model 363 and/or processed through any of a plurality of natural language models (e.g., 365 or 366) or other ML models in order to determine a text of a user’s input query or an intent value of the user’s input query. For example, an automatic speech recognition (ASR) module 363, a text embedding module 365, or a semantic similarity search module 366 that work in various combinations with one another to detect a user’s audio speech input, conversion to text or detecting text, and detecting an intent, represented by generating a query intent vector value from the text of the user query input received from the universal user conversational interface software application 370 or other interface such as one specific to an AI productivity tool enableable software application.

Further, the hardware processor 302 executing machine-readable code instructions of an intent recognition pipeline machine learning module 361 may orchestrate the interplay between each of the ASR module 363, text embedding module 365, and semantic similarity search module 366 to establish a query intent vector value in a multi-axis vector space defined with these machine learning models and correlate that query intent value with a corresponding capability intent value in an embodiment. Several text embedding algorithms may be used in various embodiments herein in order to provide a vectorized mathematical representation of semantic understanding for a user query input or for a capability described in natural language. For example, the text embedding module 365 may employ a Latent Semantic Analysis (LSA) or Latent Dirichlet allocation (LDA) which may define how close each of the observed terms in the received user query input are to various synonyms. As another example, the text embedding module 365 may employ a Word2Vec algorithm, which includes a neural network trained to understand which terms or phrases should be considered closer or further away from certain synonyms or antonyms. As yet another example, the text embedding module 365 may employ a fully recurrent neural network trained to consider the order of terms within the received user query input or the natural language descriptors of the capabilities for the AI productivity tool enableable software applications 311.

In an embodiment in which the user provides text data to the AI productivity tool enableable software application 311, such an intent recognition pipeline machine learning module 361 may truncate this process to exclude processes of the ASR module 363. The hardware processor 302 executing machine-readable code instructions of the intent recognition pipeline machine learning module 361 in an embodiment may apply the text embedding module 365 to generate a query intent value as described and then return the output query intent value of the text embedding module 365 to the query intent to application capability determination module 352. The query intent to application capability module 352 may utilize the semantic similarity search module 366 for a correlation between the query intent value received and a stored capability intent value for an application capability.

For example, in embodiments herein, a hardware processor 302 may execute machine readable code instructions for a semantic similarity search module 366, via a query intent to application capability module 352, that compares the vectorized user query input intent value and the capability intent values stored within the capability intent values database 356. Such a comparison may be performed using a semantic search machine learning model, such as a cosine similarity or other semantic similarity search algorithm that compares the distance or value difference in a multi-axis vector space between two vectors to determine the contextual similarity between the natural language description of the embedded text algorithm generated capabilities having the capability intent values and the natural language user query input having an user query input intent value generated from an embedded text algorithm. Such a contextual or semantic search methodology may take into account the fact that the same word may have two meanings or consider synonyms of words, for example based on generated intent values of multiple words or recognized phrases or parts of speech that yield the vector intent value from the text embedding algorithm machine learning models used to generate capability and query intent vector values. The cosine similarity search comparison or other semantic similarity search algorithm may be performed for several of the capability intent values stored within the capability intent value database 356 to identify a best match application capability intent value that most closely matches the user query input value, according to embodiments herein.

A hardware processor 302 executing machine readable code instructions for a semantic similarity search module 366 may determine a distance, that is a value difference of the vector intent values within the multi-axis vector space between the query input intent value and each of a plurality of capability intent values. Then, for each of those determined distances, the hardware processor executing machine readable code instructions for a semantic similarity search module 366 may determine an angular similarity having a value between zero and one for the query input intent value and each of a plurality of capability intent values. This angular similarity value in an embodiment may comprise the semantic similarity search score for a given capability intent value, where zero is a worst match and one is a best match between the given capability intent value and the query input intent value.

The hardware processor 302 in an embodiment may execute machine readable code instructions of an OTB AI productivity tool 350 query intent to application capability determination module 352 to identify the AI productivity tool enableable software application 311 natural language application capability having a highest semantic similarity search score as the best match application capability for the received user query input. For example, the detected intent having a query intent value in a multi-axis vector space, such as “get my through this meeting on battery power,” “speed up my application,” or “send a text message” may be associated with a known application capability or functionality of AI productivity tool enableable software application 311 at the information handling system. More specifically, the intent “get me through this meeting on battery power” may be associated with a capability for pausing execution of background applications, based on similarity correlation between a query intent value and a capability intent value as determined by the semantic similarity search module 366. As another example, the query intent “speed up my application” may be associated with an application capability associated with the AI productivity tool enableable software application 311 for automatically downloading and installing updates for such AI productivity tool enableable software application 311, based on similarity correlation between a query intent value and a capability intent value as determined by the semantic similarity search module 366. In yet another example, the query intent “send a text message” may be associated with an application capability of the AI productivity tool enableable software application 311 to automatically generate and transmit text messages, based on similarity correlation between a query intent value and a capability intent value as determined by the semantic similarity search module 366. As described above, these application capabilities may be registered and associated with a specific AI productivity tool enableable software application 311 at the capability intent value database 356 in an embodiment.

Upon identification of a capability that addresses the determined query “intent” of the user within the received user query input, the hardware processor 302 executing machine-readable code instructions of the OTB AI productivity tool 350 may direct execution of one or more processes at the AI productivity tool enableable software application 311, via the universal user conversational interface software application 370 associated with that application capability. For example, the hardware processor 302 executing machine-readable code instructions of the query intent to application capability determination module 352 may directly instruct the AI productivity tool enableable software application 311 to undertake the identified application capability. In such a way, the OTB AI productivity tool may implement a number of actions or utilizes services of various software applications based on the natural language of a received user query input and work in tandem with a firmware-level AI productivity tool to allow the same user queries to trigger certain actions declared and supported by firmware for various hardware components of the information handling system.

These software capabilities for various AI productivity tool enableable software applications may be specific to information handling system OS level capabilities, and may be separate from hardware and firmware capabilities invoked in parallel by the firmware-level AI productivity tool 380 that are controlled at the information handling system platform level below the operating system (OS). As described above with respect to FIG. 2, storage, access, and execution of firmware or hardware capabilities at the platform level, rather than the OS level allows for scaling and expansion of available responsive capabilities of this firmware or hardware using the firmware-level AI productivity tool 380 executing via embedded controller 304 or another hardware controller without additional burden to the processing intensive OTB AI productivity tool executing at the operating system level via a hardware processor such as the CPU. OTB AI productivity tool 350 in an embodiment may be executed at the OS level in tandem with execution of firmware-level AI productivity tool 380 identifying responsive firmware or hardware capabilities at the platform level to provide a low processing expansion of available hardware and firmware capabilities responsive to user query inputs without adding to CPU 302 usage or requiring a larger OTB AI Productivity tool 350.

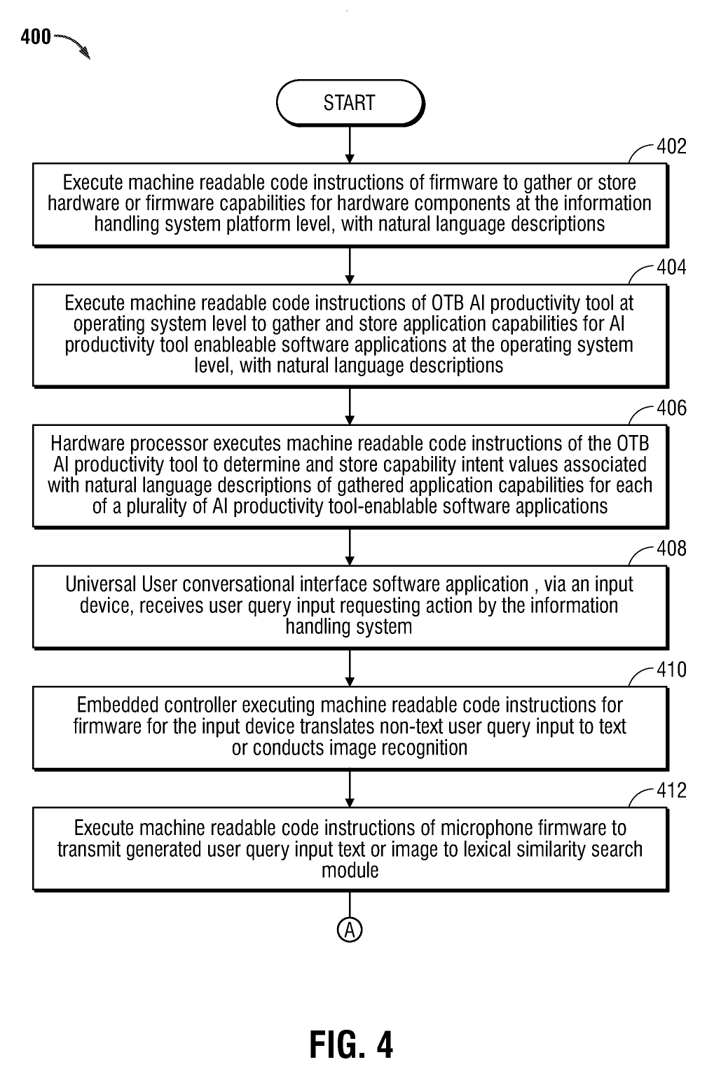

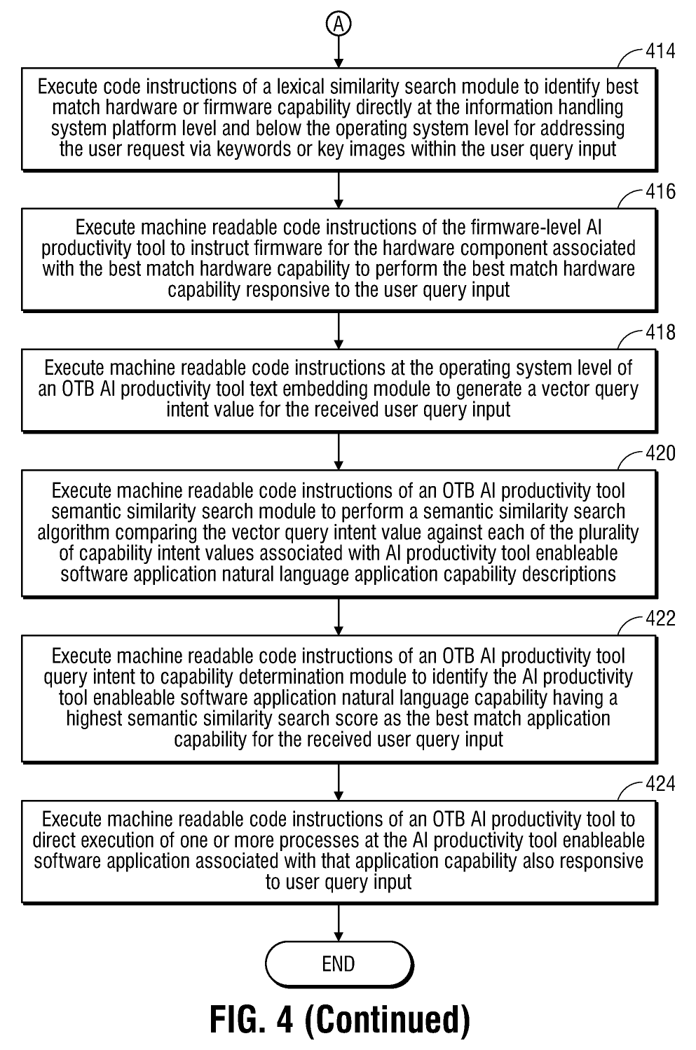

FIG. 4 is a flowchart 400 showing a method of identifying a firmware or hardware capability of a hardware component at the firmware level that best matches a received user query input through a lexical similarity search and in parallel, identifying an application capability of an AI productivity tool enableable software application at the operating system level that best matches the received user query input through a semantic similarity search according to an embodiment of the present disclosure. It is appreciated that the method 500 described herein may be executed via execution of computer readable program code instructions in firmware or software by a hardware processor or other hardware processing device such as an embedded controller on an information handling system.

The method 400 may include, at block 402, executing machine readable code instructions of firmware to gather firmware or hardware capabilities for hardware components at the information handling system platform level, with natural language descriptions. For example, in an embodiment described with respect to FIG. 2, the embedded controller 204 may execute machine readable code instructions of the firmware or hardware capabilities gathering module 295 of the firmware-level AI productivity tool 280, either in real-time or loaded prior to execution of the firmware-level AI productivity tool 280 receiving a user query input, to gather firmware or hardware capabilities for a plurality of hardware components (e.g., 208, 215, 230, 283, 286, or 290) such as determined by an information technology decision maker or manufacturer. For example, the firmware or hardware capabilities may be stored within the natural language hardware capabilities library 282 within memory for the embedded controller 204. These firmware or hardware capabilities may describe functionalities of each of the hardware components (e.g., 208, 215, 230, 283, 286, and 290) that may be used when interfacing with the firmware-level AI productivity tool 280. The natural language descriptions of the firmware or hardware capabilities for the hardware components (e.g., 208, 215, 230, 283, 286, and 290) may be stored for a lexical or keyword comparison, via the embedded controller 204 to received user query inputs, for example, in order to identify a firmware or hardware capability at the information handling system platform level most likely to address a user’s request within the received user query inputs.

A hardware processor executing machine readable code instructions of the operating system in an embodiment at block 404 may gather application capabilities for an AI productivity tool enableable software application, with natural language descriptions. For example, in an embodiment described with respect to FIG. 3, a hardware processor 302 executing machine readable code instructions for an on the box (OTB) AI productivity tool 350 may gather, either in real-time or prior to execution of the OTB AI productivity tool 350, via the capabilities gathering module 353, application capabilities associated with each of a plurality of AI productivity tool-enablable software applications 311, such as published by each of a plurality of AI productivity tool-enableable software applications 311. These application capabilities may describe those functionalities of each of the AI productivity tool-enablable software applications 311, that may be used when interfacing with the OTB AI productivity tool 350. These natural language descriptions of the application capabilities for the AI productivity tool-enableable software applications 311 may be stored within a natural language application capability database 355 for comparison to received user query inputs, for example, in order to identify an application capability most likely to address a user’s request within the received user query inputs.

At block 406, a hardware processor in an embodiment may execute machine readable code instructions of the OTB AI productivity tool at the operating system level to determine capability intent values associated with natural language descriptions of the gathered application capabilities for each of a plurality of AI productivity tool-enablable software applications. For example, the hardware processor 302 executing machine readable code instructions of the OTB AI productivity tool 350 may determine capability intent values associated with natural language descriptions of the gathered application capabilities for each of a plurality of AI productivity tool-enablable software applications 311. These capability intent values are a mathematical representation of the natural language descriptions of capability operations or services from various AI productivity tool-enablable software applications 311 in an embodiment. These capability intent values may be represented by a mathematical value in a multi-axis vector space that may be associated with the natural language description for that application capability or intent. In an embodiment, the application capabilities may also be associated with an identification (ID) such as an alphanumeric ID that may be stored within a capability intent values database 356. These application capabilities stored at the capability intent values database 356 may include any input and output capabilities provided by the AI productivity tool-enablable software applications 311 being executed by the hardware processor 302 or any other hardware processing devices, such as embedded controller 304. Generating such capability intent values as vectors may be a first step in a natural language processing method to determine an application capability corresponding to and responsive to the user’s intent or requested action within a user query input that takes into account the context or semantics of the words used within the user query input.

In an embodiment at block 408, the universal user conversational interface software application, via an input device, may receive a user query input requesting action by the information handling system. For example, in an embodiment described with respect to FIG. 2, the user may provide a user query input via an input device, such as the microphone 283, camera 286, or keyboard 290 which may be transmitted to the universal user conversational interface software application 270. In another example embodiment, the user may provide a text user query input via a keyboard 290.

At block 410, in an embodiment, an embedded controller executing machine readable code instructions for firmware for the input device may translate received non-text user query input to text for executing keyword spotting of particular keywords from the text. This keyword spotting may also occur from direct text entry such as with a keyboard. Video data may be transmitted as well to firmware level AI productivity tool 280 for execution of image recognition to find key images such as for gestures and the like. For example, in an embodiment described with respect to FIG. 2, firmware 284, 287, or 291 for the receiving input device, such as the microphone 281, the camera 286, or the keyboard 290 respectively, may translate audio or image user query input to text and transmit the text user query input directly to the firmware-level AI productivity tool 280. The keyboard 290 may provide for the text user query input to the firmware level AI productivity tool 280. Upon detection of receipt of such a user query input at firmware (e.g., microphone firmware 284, camera firmware 287, or keyboard firmware 291) for the microphone 283, camera 286, or keyboard 290 in an embodiment, this audio or image of the user query input may be translated to text via firmware of the microphone 283, camera 286, or keyboard 290, respectively, or image recognition module 287 may conduct image recognition for image parameters to be used for correlation to key images. For example, the microphone firmware 284 may include a microphone automated speech recognition (ASR) module 285 to detect words within the recorded voice data and generate text representing the detected words. As another example, the camera firmware 287 may include an image recognition module 288 to translate captured images of the user into image recognition parameters to match with key image parameter sets. In some specific example embodiments, the image recognition module 288 may be capable of interpreting a captured image of a user with both palms up and facing the screen as either the text “stop” or a correspond the received user query input image data with a key image associated with a stop action for a particular hardware component. In another specific example embodiment, by the image recognition module 288 may be capable of interpreting a plurality of captured images of a user swiping a hand past the lens as text for “move to next” or a key image associated with a move or next action for a particular hardware component. In yet other example embodiments, the image recognition module 288 may be capable of interpreting a captured image of a user for translating various gestures or words and phrases of known sign languages such as American Sign Language (ASL) or English Sign Language (ESL).

An embedded controller or other hardware controller executing at an information handling system platform level (below the operating system (OS)) in an embodiment at block 412 may execute machine readable code instructions of firmware for the input device to transmit the generated or existing user query input text or image text with image recognition parameters to a lexical similarity search module. For example, in an embodiment in which the input device is camera 286, the camera firmware 287 may execute, via the embedded controller 204 to transmit the text or image text with image recognition parameters for the user query input translated from a captured image to the lexical similarity search module 293. As another example, in an embodiment in which the input device is microphone 283, the microphone firmware 284 may execute, via the embedded controller 204 to transmit the text user query input translated from captured audio to the lexical similarity search module 293. As yet another example, the keyboard firmware 291 may include a keyboard text recognition module 292 to detect or spot words within received or detected keystrokes representing the detected words which may be keywords.

At block 414 in an embodiment, an embedded controller or other hardware controller at the information handling system platform level may execute code instructions of a lexical similarity search module to match natural language text keywords or image parameters from of received user query input with a natural language description of firmware or hardware capability or associated gesture key image parameters for hardware component that most closely corresponds and can address the user request within the user query input. For example, an embedded controller 204 executing code instructions of a lexical similarity search module of the firmware-level AI productivity tool 280 in an embodiment may perform a lexical similarity search method to match the natural language text of the received user query input with a natural language description of a firmware or hardware capability stored in the natural language hardware capabilities library 282 in order to identify a firmware or hardware capability for hardware component (e.g., 208, 215, 230, 283, 286, or 290) of the information handling system directly at the information handling system platform level and below the OS level that most closely corresponds and can address the user request within the user query input. A lexical similarity search methodology for matching text or documents in embodiments herein may center upon keyword searches, such as term frequency-inverse document frequency (TF-IDF) searches. TF-IDF searches in this context focus upon the frequency of a term or keyword found within a user query input and within known firmware or hardware capabilities for the various hardware components (e.g., 208, 215, 230, 283, 286, or 290). TF-IDF methodologies are effective and processor non-intensive, making them well-suited when a single keyword within the user query input is most important to identifying a matching firmware or hardware capability for a hardware component (e.g., 208, 215, 230, 283, 286, or 290) to address the user’s concerns.

In another example embodiment described in reference to FIG. 2, the embedded controller 204 executing code instructions for the camera image recognition module 288 may perform an image recognition algorithm or use a convolutional neural network, such as a trained neural network, to identify one or more parameters, features, identified objects, edges, or patterns within images captured by the camera 286 correlating to parameters, features, identified objects, edges, or patterns within key images stored in the natural language hardware capabilities library 282 to represent one or more hardware or firmware capabilities. In one specific example embodiment, the camera 286 may capture one or more images of a user showing palms in a gesture for “stop.” In such a scenario, the embedded controller 204 executing code instructions for the camera image recognition module 288 may determine that firmware or hardware capabilities stored within the natural language hardware capability library 282 such as “stop operating a speaker” may have non-zero lexical image similarity search scores above a threshold level such that it is the responsive capability intent action to the received user query input image data.

Returning to the keyword matching example embodiment, the embedded controller 204 executing code instructions for the lexical similarity search module 293 may perform a TF-IDF algorithm to measure the frequency with which each of a plurality of natural language terms appear within the user query input, as weighted by the frequency with which that term occurs in one of each of the natural language firmware or hardware capabilities stored within the natural language hardware capability library 282. More specifically, the hardware processor executing code instructions for a TF-IDF algorithm may determine a TF-IDF similarity score measuring the frequency with which each of a plurality of natural language terms, including names of various hardware components (e.g., 208, 215, 230, 283, 286, or 290) or terms appearing in adjustable settings or policies for those hardware components appear in the user query input, as weighted by the frequency with which each of those terms also occur within each of the natural language firmware or hardware capabilities stored at the natural language hardware capabilities library 282. This comparison may be repeated for each of the firmware or hardware capabilities stored within the natural language hardware capability library 282, to produce a lexical similarity search score for each of the firmware or hardware capabilities. Each TF-IDF similarity score determined in such a way may have a value between zero and one. Thus, if there is a TF-IDF match between a term in a natural language description of a firmware or hardware capability, that firmware or hardware capability will have an increased weighting for a match over other firmware or hardware capabilities that do not contain this term in embodiments herein. Further, if there are multiple TF-IDF matches between a plurality of terms in a natural language description of a firmware or hardware capability, that firmware or hardware capability will have an increased weighting for a match over other firmware or hardware capabilities that only contain one matching term in embodiments herein. Similar matching correlation may be conducted for key images from received user query input image data in embodiments herein with image recognition parameters and correlation to parameters in key images, of for example gestures, for association with hardware or firmware capabilities in natural language hardware capabilities library 282 in other embodiments.

In some embodiments, the embedded controller 204 may execute code instructions for the query intent to firmware or hardware capabilities determination module 294 to identify all firmware or hardware capabilities associated with a lexical similarity search score above a threshold value (e.g., 0.05. 0.1, 0.2) or a key image correlation score threshold for a gesture as best match firmware or hardware capabilities for execution at firmware (e.g., 207, 216, 234, 284, 287) in response to the received user query input. In other embodiments, the embedded controller 204 may execute code instructions for the query intent to firmware or hardware capabilities determination module 294 to identify a single firmware or hardware capability associated with a highest lexical similarity search score or a key image correlation score threshold in comparison to lexical similarity search scores or key image correlation scores for all other firmware or hardware capabilities stored within the natural language hardware capability library 282 as best match firmware or hardware capabilities for execution at firmware (e.g., 207, 216, 234, 284, 287) in response to the received user query input.

The embedded controller executing machine readable code instructions of the firmware-level AI productivity tool in an embodiment at block 416 may then, independently of the operating system, instruct firmware for the hardware component associated with the best match firmware or hardware capability to perform the best match firmware or hardware capability. For example, the firmware-level AI productivity tool 280 in an embodiment may then, independently of the operating system and without requiring execution by a central processing unit (CPU) of the OTB AI productivity tool 250 or expansion of the size of the OTB AI productivity tool 250, instruct firmware (e.g., 207, 216, 234, 284, 287) for the hardware component (e.g., 208, 215, 230, 283, 286, respectively) associated with the best match firmware or hardware capability to perform the best match firmware or hardware capability in response to a user query input. For example, in an embodiment in which the embedded controller 204 executing code instructions for the lexical similarity search module 293 determines that the firmware or hardware capability “place battery in power save mode” is a best match firmware or hardware capability, the embedded controller 204 may instruct battery firmware 207 to place the battery in a preset power save mode to conserve power.

In another example, in an embodiment in which the embedded controller 204 executing code instructions for the lexical similarity search module 293 determines that the firmware or hardware capability “reduce camera frame capture rate” is a best match firmware or hardware capability, the embedded controller 204 may instruct the camera firmware 287 to reduce the frame capture rate for the camera. In still another example, in an embodiment in which the embedded controller 204 executing code instructions for the lexical similarity search module 293 determines that the firmware or hardware capability “turn off audio codecs” is a best match firmware or hardware capability, the embedded controller 204 may instruct the microphone firmware 284 to disable audio codec processing on incoming audio. As yet another example, in an embodiment in which the embedded controller 204 executing code instructions for the lexical similarity search module 293 determines that the firmware or hardware capability “turn off Bluetooth ®” is a best match firmware or hardware capability, the embedded controller 204 may instruct the RF front end 234 to turn off a Bluetooth ® radio or antenna and rely solely on Wi-Fi (WLAN) or cellular (WWAN) signals. In still another example, in an embodiment in which the embedded controller 204 executing code instructions for the lexical similarity search module 293 determines that the firmware or hardware capability “reduce display resolution” is a best match firmware or hardware capability, the embedded controller 204 may instruct the display device firmware 216 to decrease the display resolution from high-definition to standard definition.

In such a way, the embedded controller 204 executing code instructions of the firmware-level AI productivity tool 280 in an embodiment may match the received user query inputs to known firmware or hardware capabilities of one or more hardware components (e.g., 208, 215, 230, 283, 286, or other components) through execution by the embedded controller 204 of machine readable code instructions for the firmware-level AI productivity tool 280 to expand responsive capability actions without additional size or computational burden on an OTB AI productivity tool executing at the information handling system by a hardware processor (e.g., CPU) at the OS level.

At block 418, the hardware processor operating at the operating system level in an embodiment may execute machine readable code instructions of an OTB AI productivity tool text embedding module in tandem to the firmware level AI productivity tool, to generate a vector query intent value for the received user query input. As described herein, a hardware processor executing code instructions of the OTB AI productivity tool in an embodiment may match the same user query input received and processed at the firmware level, as described above with respect to blocks 408-416, to known application capabilities of one or more of the AI productivity tool-enableable software applications through execution by the hardware processor of machine readable code instructions for one or more natural language processing machine learning models executing at the operating system and having similar but more robust operations than the natural language processing machine learning models executing at the firmware level via the firmware-level AI productivity tool, using a semantic search methodology, rather than a lexical search methodology, or in connection with a lexical search methodology executed by the OTB AI productivity tool. For example, in an embodiment described with respect to FIG. 3 the hardware processor 302 may execute machine-readable code instructions of the query intent determination module 351 to receive the user query input via microphone, image, or text input, and initiate execution of machine readable code instructions for an intent recognition pipeline machine learning module 361. In an embodiment, the hardware processor 302 executing machine-readable code instructions for the intent recognition pipeline machine learning module 361 may further orchestrate any combination of a plurality of machine learning modules (e.g., 363, 365, or 366) to process the audio, image, or text input to determine the user’s intended goal or query intent within the received text or voice data of the user query input.

During operation for example, the hardware processor 302 executing machine-readable code instructions of the query intent determination module 351 may load one or more machine learning models such that, for example, the text or voice input from the user may be processed through a speech recognition model 363 and/or processed through any of a plurality of natural language models (e.g., 365 or 366) or other ML models in order to determine a text of a user’s input query or an intent value of the user’s input query. For example, an automatic speech recognition (ASR) module 363, a text embedding module 365, or a semantic similarity search module 366 that work in various combinations with one another to detect a user’s audio speech input, conversion to text or detecting text, and detecting an intent, represented by generating a query intent vector value from the text of the user query input received from the universal user conversational interface software application 370 or other interface such as one specific to an AI productivity tool enableable software application. Further, the hardware processor 302 executing machine-readable code instructions of an intent recognition pipeline machine learning module 361 may orchestrate the interplay between each of the ASR module 363, text embedding module 365, and semantic similarity search module 366 to establish a query intent vector value in a multi-axis vector space defined with these machine learning models and correlate that query intent value with a corresponding capability intent value in an embodiment. The hardware processor 302 executing machine-readable code instructions of the intent recognition pipeline machine learning module 361 in an embodiment may apply the text embedding module 365 to generate a query intent value as described and then return the output query intent value of the text embedding module 365 to the query intent to application capability determination module 352.

At block 420, the hardware processor in an embodiment may execute machine readable code instructions of an OTB AI productivity tool semantic similarity search module to perform a semantic similarity search algorithm comparing the vector query intent value against each of the plurality of capability intent values associated with AI productivity tool enableable software application natural language application capability descriptions. For example, in reference to an embodiment described with reference to FIG. 3, a hardware processor 302 may execute machine readable code instructions for a semantic similarity search module 366, via a query intent to application capability module 352, that compares the vectorized user query input intent value and the capability intent values stored within the capability intent values database 356. Such a comparison may be performed using a semantic search machine learning model, such as a cosine or other semantic similarity search algorithm that compares the distance or value difference in a multi-axis vector space between two vectors to determine the contextual similarity between the natural language description of the embedded text algorithm generated capabilities having the capability intent values and the natural language user query input having an user query input intent value generated from an embedded text algorithm. Such a contextual or semantic search machine learning model may take into account the fact that the same word may have two meanings or consider synonyms of words, for example based on generated intent values of multiple words or recognized phrases or parts of speech that yield the vector intent value from the text embedding algorithm machine learning models used to generate capability and query intent vector values. The cosine similarity search comparison or other semantic similarity search algorithm may be performed for several of the capability intent values stored within the capability intent value database 356 to identify a best match application capability intent value that most closely matches the user query input value, according to embodiments herein.

A hardware processor 302 executing machine readable code instructions for a semantic similarity search module 366 may determine a distance, that is a value difference of the vector intent values within the multi-axis vector space between the query input intent value and each of a plurality of capability intent values. Then, for each of those determined distances, the hardware processor executing machine readable code instructions for a semantic similarity search module 366 may determine an angular similarity having a value between zero and one for the query input intent value and each of a plurality of capability intent values. This angular similarity value in an embodiment may comprise the semantic similarity search score for a given capability intent value, where zero is a worst match and one is a best match between the given capability intent value and the query input intent value.

The hardware processor in an embodiment at block 422 may execute machine readable code instructions of an OTB AI productivity tool query intent to capability determination module to identify the AI productivity tool enableable software application natural language application capability having a highest semantic similarity search score as the best match application capability for the received user query input. This is the same user query input as used with the firmware level AI productivity tool in some embodiments herein. For example, in an embodiment described with reference to FIG. 3, the query intent to application capability module 352 may utilize the semantic similarity search module 366 for a correlation between the query intent value received and a stored capability intent value for an application capability. More specifically, the detected intent having a query intent value in a multi-axis vector space, such as “get my through this meeting on battery power,” “speed up my application,” or “send a text message” may be associated with a known application capability or functionality of AI productivity tool enableable software application 311 at the information handling system. In another example, the intent “get me through this meeting on battery power” may be associated with a capability for pausing execution of background applications, based on similarity correlation between a query intent value and a capability intent value as determined by the semantic similarity search module 366. As another example, the query intent “speed up my application” may be associated with an application capability associated with the AI productivity tool enableable software application 311 for automatically downloading and installing updates for such AI productivity tool enableable software application 311, based on similarity correlation between a query intent value and a capability intent value as determined by the semantic similarity search module 366. In yet another example, the query intent “send a text message” may be associated with an application capability of the AI productivity tool enableable software application 311 to automatically generate and transmit text messages, based on similarity correlation between a query intent value and a capability intent value as determined by the semantic similarity search module 366. As described above, these application capabilities may be registered and associated with a specific AI productivity tool enableable software application 311 at the capability intent value database 356 in an embodiment.

In an embodiment at block 424, the hardware processor may execute machine readable code instructions of an OTB AI productivity tool to instruct the AI productivity tool enableable software application associated with the best match application capability for the received user query input to execute the best match application capability that is also responsive to the received user query input. Upon identification of a capability that addresses the determined user query “intent” of the user within the received user query input, the hardware processor 302 executing machine-readable code instructions of the OTB AI productivity tool 350 may direct execution of one or more processes at the AI productivity tool enableable software application 311 associated with that application capability. For example, the hardware processor 302 executing machine-readable code instructions of the query intent to application capability determination module 352 may directly instruct the AI productivity tool enableable software application 311 to undertake the identified application capability. In such a way, the OTB AI productivity tool may implement a number of actions or utilizes services of various software applications at the operating system level based on the natural language of a received user query input and work in tandem with a firmware-level AI productivity tool to allow the same user queries to trigger certain actions declared and supported by firmware for various hardware components of the information handling system. This expands responsive capability actions without additional size or computational burden on an OTB AI productivity tool executing at the information handling system by a hardware processor (e.g., CPU) at the OS level. The method for identifying a firmware or hardware capability of a hardware component at the firmware level that best matches a received user query input through a lexical similarity search and, in tandem, identifying an application capability of an AI productivity tool enableable software application at the operating system level , via hardware processor execution of an OTB AI productivity tool, that best matches the received user query input through a semantic similarity search may then end.

The blocks of the flow diagram of FIG. 4 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system executing computer readable code instructions for a firmware-level artificial intelligence (AI) productivity tool comprising:
a microphone for receiving a user query input requesting an action to be taken by one of a plurality of hardware components or for an AI productivity tool-enableable software application executing via an operating system of the information handling system;
an embedded controller executing computer-readable code instructions for accessing gathered natural language descriptions of firmware and hardware capabilities associated with each of the plurality of hardware components for the information handling system stored via a natural language hardware capabilities library at memory accessible to the embedded controller;
the embedded controller executing computer-readable program code instructions for performing a text frequency-inverted document frequency (TF-IDF) comparison between natural language of the user query input including a keyword identified in the user query input and each of the natural language descriptions for the gathered hardware and firmware capabilities to generate a lexical similarity search score for each of the natural language descriptions for the gathered firmware and hardware capabilities;
the embedded controller executing computer-readable program code instructions for identifying a best match firmware or hardware capability for the received user query input having a highest lexical similarity search score with the keyword identified in the user query input; and
the embedded controller executing computer-readable program code instructions for instructing firmware for one or more of the plurality of hardware components associated with the best match firmware or hardware capability to execute the best match firmware or hardware capability in response to the user query input at an information handling system platform level without invoking an on the box (OTB) AI productivity tool at an operating system of the information handling system.

2. The information handling system of claim 1 further comprising:
the firmware for the hardware component performing the best match firmware or hardware capability to place a battery in a preset power save mode to conserve power, via instructions executed at the information handling system platform level.

3. The information handling system of claim 1 further comprising:
the firmware for the hardware component performing the best match firmware or hardware capability to reduce a frame capture rate for a camera, via instructions executed at the information handling system platform level.

4. The information handling system of claim 1 further comprising:
the firmware for the hardware component performing the best match firmware or hardware capability to disable audio codec processing on incoming audio received via the microphone, via instructions executed at the information handling system platform level.

5. The information handling system of claim 1 further comprising:
the firmware for the hardware component performing the best match firmware or hardware capability to turn off a Bluetooth ® radio or antenna of a wireless network interface device, via instructions executed at the information handling system platform level.

6. The information handling system of claim 1 further comprising:
a hardware processor to receive the query input in tandem with the embedded controller;
the hardware processor executing computer-readable program code instructions at the operating system level for generating a query input intent value for the user query input;
the hardware processor executing computer-readable program code instructions for performing a semantic similarity search comparing the query input intent value to a plurality of capability intent values generated from natural language descriptions of gathered capabilities associated with each of a plurality of AI productivity tool-enablable software applications executing at the operating system level; and
the hardware processor executing computer-readable program code instructions for identifying a best match application capability for the received user query input having a capability intent value that generates a highest semantic similarity search score.

7. The information handling system of claim 6 further comprising:
the hardware processor executing computer-readable program code instructions for instructing a first of the plurality of AI productivity tool-enableable software applications having the best match application capability to execute the best match application capability in response to the user query input.

8. A method for firmware of a hardware component to select a capability of the hardware component of an information handling system in responding to a user query input comprising:
receiving, via an input device, a user query input requesting an action to be taken by one of a plurality of hardware components at an AI productivity tool-enableable software application executing via an operating system of the information handling system;
accessing gathered natural language descriptions of hardware or firmware capabilities of hardware components operable at an information handling system platform level stored in a natural language hardware capabilities library via an embedded controller executing computer-readable program code instructions of a firmware-level AI productivity tool;
executing computer-readable program code instructions to perform a text frequency-inverted document frequency (TF-IDF) comparison, via the embedded controller, between natural language keywords of the user query input and each of the natural language descriptions for the gathered hardware or firmware capabilities to generate a lexical similarity search score for each of the natural language descriptions for the gathered hardware or firmware capabilities to identify a best match firmware or hardware capability for the received user query input having a highest lexical similarity search score;
instructing, via the embedded controller executing computer-readable program code instructions firmware at the information handling system platform level, one or more of the plurality of hardware components associated with the best match hardware or firmware capability to execute the best match firmware or hardware capability in response to the user query input without invoking an on the box (OTB) AI productivity tool at an operating system level; and
forwarding the user query input to the OTB AI productivity tool executing, in tandem, via a hardware processor at the operating system level to determine responsive a capability intent action from at least one AI productivity tool enableable software application to the user query input.

9. The method of claim 8 further comprising:
executing machine readable code instructions, via the embedded controller, for an image recognition module operating as firmware for the input device to translate the received user query input in the form of a captured image or a series of captured images into image recognition parameters for matching with a key image associated with the best match hardware or firmware capability responsive to the user query input.

10. The method of claim 8, wherein the input device is a camera and the user query input is given within one or more captured images to match with a series of key images of a gesture associated with the best match hardware or firmware capability in the natural language hardware capabilities library.

11. The method of claim 8 further comprising:
receiving, via a hardware processor, the query input in tandem with the embedded controller;
executing computer-readable program code instructions at the operating system level, via the hardware processor, for generating a query input intent value for the user query input;
executing computer-readable program code instructions, via the hardware processor, for performing a semantic similarity search comparing the query input intent value to a plurality of capability intent values generated from natural language descriptions of gathered capabilities associated with each of a plurality of AI productivity tool-enablable software applications executing at the operating system level; and
executing computer-readable program code instructions, via the hardware processor, for identifying a best match application capability for the received user query input having a capability intent value that generates a highest semantic similarity search score.

12. The method of claim 8, wherein the input device is a microphone and the user query input is given within captured audio.

13. The method of claim 8 further comprising:
the embedded controller executing machine readable code instructions for an automatic speech recognition module operating as firmware for the input device to translate the received user query input in the form of captured audio into natural language text.

14. The method of claim 8, wherein the input device is a keyboard and the user query input is given in text input.

15. An information handling system executing computer readable code instructions for a firmware-level artificial intelligence (AI) productivity tool comprising:
a microphone for receiving a user query input requesting an action to be taken by one of the plurality of hardware components and for an AI productivity tool-enableable software application executing via an operating system of the information handling system;
an embedded controller executing computer-readable code instructions for accessing gathered natural language descriptions of firmware or hardware capabilities associated with each of a plurality of hardware components for the information handling system and stored in a natural language hardware capabilities library in memory accessible to the embedded controller;
the embedded controller executing computer-readable code instructions for performing a lexical comparison between a keyword identified in natural language of the user query input and each of the natural language descriptions for the gathered firmware or hardware capabilities to generate a lexical similarity search score for each of the natural language descriptions for the gathered firmware or hardware capabilities and to identify a best match firmware or hardware capability for the received user query input having a highest lexical similarity search score;
a hardware processor executing computer-readable program code instructions in tandem at the operating system level for generating a query input intent value from the user query input, performing a semantic similarity search comparing the query input intent value to a plurality of capability intent values generated from natural language descriptions of gathered application capabilities associated with each of a plurality of AI productivity tool-enablable software applications, and identifying a best match application capability for the received user query input having a capability intent value that generates a highest semantic similarity search score; and
the embedded controller executing computer-readable program code instructions for instructing firmware for one or more of the plurality of hardware components associated with the best match firmware or hardware capability to execute the best match firmware or hardware capability in response to the user query input at an information handling system platform level.

16. The information handling system of claim 15 further comprising:
the hardware processor executing computer-readable program code instructions for instructing a first of the plurality of AI productivity tool-enableable software applications having the best match application capability to execute the best match application capability in response to the user query input in tandem with the best match hardware capability.

17. The information handling system of claim 15, wherein the capability intent values are generated by execution of code instructions for a text embedding algorithm and mathematically represent semantic meaning for words or phrases within the natural language descriptions for the gathered application capabilities for correlation with the query intent input value generated from the user query input text.

18. The information handling system of claim 15 further comprising:
the embedded controller executing machine readable code instructions for an image recognition module operating as firmware for the input device to translate the received user query input in the form of a captured image or a series of captured images into image recognition parameters for matching to key image parameters via a key image correlation score for a key image associated with the best match firmware or hardware capability.

19. The information handling system of claim 15 further comprising:
the firmware for the hardware component performing the best match firmware or hardware capability to decrease a display resolution for a display device from high-definition to standard definition, via instructions executed at the information handling system platform level.

20. The information handling system of claim 15 further comprising:
the AI productivity tool enable software application performing the best match application capability to pause execution of background software applications, via instructions executed at the operating system level.
